(19) United States
(12) Patent Application Publication
(10) Pub. No.: US 2025/0298863 A1
(43) Pub. Date: Sep. 25, 2025

(54) SYSTOLIC ARRAY MATRIX MULTIPLIER AND METHOD OF OPERATING SYSTOLIC ARRAY MATRIX MULTIPLIER

(71) Applicant: Fujitsu Limited, Kawasaki-shi (JP)

(72) Inventor: Kentaro KAWAKAMI, Kawasaki (JP)

(73) Assignee: Fujitsu Limited, Kawasaki-shi (JP)

(21) Appl. No.: 19/011,929

(22) Filed: Jan. 7, 2025

(30) Foreign Application Priority Data
Mar. 22, 2024 (JP) 2024-045839

(51) Int. Cl. G06F 17/16

(52) U.S. Cl. CPC G06F 17/16

(57) ABSTRACT

A systolic array matrix multiplier executes matrix multiplication and includes processing element which each includes: a first holder that retains each element of a first matrix received from a first input terminal provided on one end side; a first path that outputs an output of the first holder to a first output terminal provided on another end side; a second holder that retains each element of the first matrix received from a second input terminal provided on the another end side; a second path that outputs an output of the second holder to a second output terminal provided on the one end side; a product-sum operator coupled to the first path; a first selector that couples the first path or the second input terminal to the second path; and a second selector that couples the second path or the output of the first holder to the first path.

### CROSS-REFERENCE TO RELATED APPLICATION

This application is based upon and claims the benefit of priority of the prior Japanese Patent Application No. 2024-45839, filed on Mar. 22, 2024, the entire contents of which are incorporated herein by reference.

### FIELD

The embodiment discussed herein is related to a systolic array matrix multiplier and a method of operating the systolic array matrix multiplier.

### BACKGROUND

Operations used in scientific and technical computation, machine learning, and the like often make a greater use of matrix operations. It is known that a large-scale matrix operation using a general-purpose central processing unit (CPU) has a limit in performance improvement. In view of the above, there has been proposed a systolic array accelerator that arranges a plurality of processing elements vertically and horizontally and executes large-scale matrix multiplication at high speed.

U.S. Patent Application Publication No. 2018-0267936 is disclosed as related art.

### SUMMARY

According to an aspect of the embodiments, a systolic array matrix multiplier is configured to execute matrix multiplication and includes a plurality of processing elements arranged in a matrix. Each of the plurality of processing elements includes: a first holder that sequentially retains each element of a first matrix received from a first input terminal provided on one end side in a first direction; a first path that outputs an output of the first holder to a first output terminal provided on another end side in the first direction; a second holder that sequentially retains each element of the first matrix received from a second input terminal provided on the another end side in the first direction; a second path that outputs an output of the second holder to a second output terminal provided on the one end side in the first direction; a product-sum operator coupled to the first path; a first selector that couples the first path or the second input terminal to the second path; and a second selector that couples the second path or the output of the first holder to the first path.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a systolic array matrix multiplier according to an embodiment;

FIG. 2 is a block diagram illustrating an example of a processing element in FIG. 1;

FIG. 3 is a diagram illustrating exemplary matrix multiplication executed by a systolic array in FIG. 1;

FIG. 4 is a block diagram illustrating an exemplary information processing apparatus in which the systolic array in FIG. 1 is installed;

FIG. 5 is a block diagram illustrating an example of another systolic array matrix multiplier;

FIG. 6 is a diagram illustrating an outline of operation of the systolic array matrix multiplier in FIG. 5;

FIG. 7 is a block diagram illustrating an example of still another systolic array matrix multiplier;

FIG. 8 is a diagram illustrating exemplary operation of the systolic array matrix multiplier in FIG. 1;

FIG. 9 is a diagram illustrating a continuation of FIG. 8;

FIG. 10 is a diagram illustrating a continuation of FIG. 9;

FIG. 11 is a diagram illustrating a continuation of FIG. 10;

FIG. 12 is a diagram illustrating a continuation of FIG. 11;

FIG. 13 is a diagram illustrating a continuation of FIG. 12;

FIG. 14 is a diagram illustrating a continuation of FIG. 13;

FIG. 15 is a diagram illustrating a continuation of FIG. 14;

FIG. 16 is a diagram illustrating a continuation of FIG. 15;

FIG. 17 is a diagram illustrating a continuation of FIG. 16;

FIG. 18 is a diagram illustrating a continuation of FIG. 17;

FIG. 19 is a diagram illustrating an example of values output from each flip-flop of an upper right PE+in the systolic array in FIG. 1;

FIG. 20 is a diagram illustrating another exemplary operation of the systolic array matrix multiplier in FIG. 1;

FIG. 21 is a diagram illustrating a continuation of FIG. 20;

FIG. 22 is a diagram illustrating a continuation of FIG. 21;

FIG. 23 is a diagram illustrating a continuation of FIG. 22;

FIG. 24 is a diagram illustrating a continuation of FIG. 23;

FIG. 25 is a diagram illustrating a continuation of FIG. 24;

FIG. 26 is a diagram illustrating a continuation of FIG. 25;

FIG. 27 is a diagram illustrating exemplary operation in a case of executing four matrix multiplications in parallel by dividing the systolic array in FIG. 1 into four parts of two rows and two columns;

FIG. 28 is a diagram illustrating a continuation of FIG. 27;

FIG. 29 is a diagram illustrating a continuation of FIG. 28;

FIG. 30 is a diagram illustrating a continuation of FIG. 29;

FIG. 31 is a diagram illustrating a continuation of FIG. 30;

FIG. 32 is a diagram illustrating a continuation of FIG. 31;

FIG. 33 is a diagram illustrating a continuation of FIG. 32; and

FIG. 34 is a diagram illustrating features of the systolic array matrix multipliers in FIGS. 2, 5, and 7.

### DESCRIPTION OF EMBODIMENTS

A size of a systolic array increases as a size of a matrix for executing an operation increases. For example, in a case of executing, with the systolic array, an operation of a matrix smaller than the maximum size that may be executed by the systolic array, some processing elements are used only to transfer elements of the matrix.

At this time, a product-sum operator included in the processing element executes a useless operation (0×0+C) so that a product-sum operation result C transferred from the upstream is not changed. Since the number of processing elements that execute a substantial operation is reduced, the processing efficiency of the operation is lowered.

Operations of a plurality of sizes of matrices may be executed by the processing elements in the systolic array being made divisible. However, in this case, a memory is needed for each group of the processing elements to be divided, which increases a circuit scale.

Moreover, in a case of making an input of data to be used for the operation to the systolic array and an output of an operation result from the systolic array in parallel, operation performance may be decreased due to band limitation of a bus coupled to the systolic array.

In one aspect, an object of the embodiment is to provide a systolic array matrix multiplier capable of suppressing a decrease in operation performance caused by band limitation of a bus.

Hereinafter, an embodiment will be described with reference to the drawings.

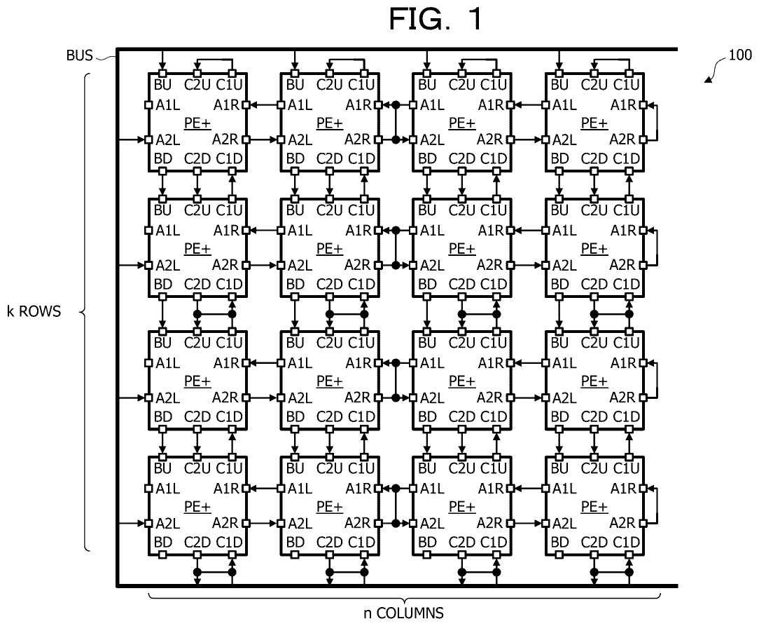

FIG. 1 illustrates an example of a systolic array matrix multiplier according to an embodiment. A systolic array matrix multiplier 100 illustrated in FIG. 1 includes a plurality of processing elements PE+ arranged in a matrix, and a bus BUS coupled to the processing elements PE+ and arranged therearound. Hereinafter, the systolic array matrix multiplier 100 will also be referred to as a systolic array 100, and the processing element PE+ will also be referred to as a PE+.

The systolic array 100 causes the plurality of PE+ to compute data in a bucket brigade manner, thereby performing a process of multiplying an m-by-k matrix A by a k-by-n matrix B and adding a result of the m-by-n multiplication to an m-by-n matrix C (e.g., m, k, and n are integers of 2 or more). Note that, hereinafter, descriptions will be given on the assumption that m=n=k holds for simplification. The matrix A is an example of a first matrix, and the matrix C is an example of a second matrix.

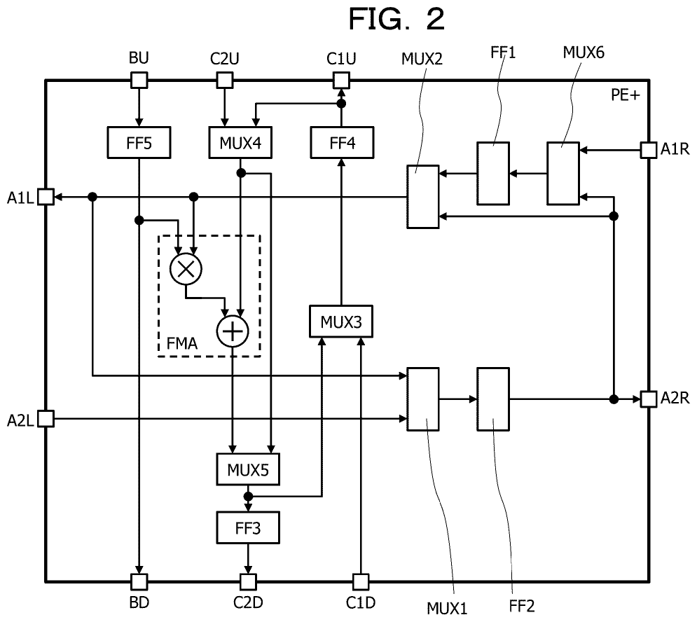

Furthermore, while FIG. 1 illustrates an exemplary case where the systolic array 100 includes 16 pieces of PE+ of 4 rows and 4 columns with k=4 and n=4, the systolic array 100 may include a larger number of PE+, such as 8 rows and 8 columns, 16 rows and 16 columns, or the like. Furthermore, the number of rows and the number of columns may be different. While return paths are illustrated around some of the PE+ in FIG. 1, the return paths are practically included inside the PE+. An exemplary internal configuration of the PE+ is illustrated in FIG. 2.

In each PE+, a right input terminal A1R and a left input terminal A2L may input each element of the matrix A, and a left output terminal A1L and a right output terminal A2R may output each element of the matrix A. In each PE+, an upper input terminal BU may input each element of the matrix B, and a lower output terminal BD may output each element of the matrix B. In each PE+, an upper input terminal C2U and a lower input terminal C1D may input each element of the matrix C, and a lower output terminal C2D and an upper output terminal C1U may output each element of the matrix C. Hereinafter, elements included in the respective matrices A, B, and C will also be referred to as data.

The input terminal A1R is an example of a first input terminal, and the output terminal A1L is an example of a first output terminal. The input terminal A2L is an example of a second input terminal, and the output terminal A2R is an example of a second output terminal. The input terminal C2U is an example of a third input terminal, and the output terminal C2D is an example of a third output terminal. The input terminal C1D is an example of a fourth input terminal, and the output terminal C1U is an example of a fourth output terminal.

For example, in the systolic array 100 illustrated in FIG. 1, data of the matrix A and data of the matrix C are relayed from the upper right PE+ toward the lower left PE+ in a bucket brigade manner. Data of the matrix B is transferred to each PE+ in advance. For example, each PE+executes an operation of “A×B+C” using a product-sum operator FMA illustrated in FIG. 2, and transfers a result of the operation to a lower PE+ as data of the matrix C.

FIG. 2 illustrates an example of the processing element PE+ in FIG. 1. The PE+ includes flip-flops FF1, FF2, FF3, FF4, and FF5, multiplexers MUX1, MUX2, MUX3, MUX4, MUX5, and MUX6, and the product-sum operator FMA. The product-sum operator FMA multiplies the data of the matrix A by the data of the matrix B using a multiplier, and adds a result of the multiplication to the data of the matrix C using an adder.

Each of the flip-flops FF1, FF2, FF3, FF4, and FF5 may retain one element of the matrix. For example, the multiplexers MUX1 to MUX6 of each PE+ may be controlled independently of each other by a sequencer disposed outside the systolic array 100. Hereinafter, the flip-flops FF1, FF2, FF3, FF4, and FF5 will also be referred to as an FF1, FF2, FF3, FF4, and FF5, respectively. The multiplexers MUX1, MUX2, MUX3, MUX4, MUX5, and MUX6 will also be referred to as an MUX1, MUX2, MUX3, MUX4, MUX5, and MUX6, respectively. The product-sum operator FMA will also be referred to as an FMA.

The FF1 is an example of a first holder, and the FF2 is an example of a second holder. The FF3 is an example of a third holder, and the FF4 is an example of a fourth holder. The multiplexer MUX1 is an example of a first selector, and the multiplexer MUX2 is an example of a second selector. The multiplexer MUX3 is an example of a third selector, and the multiplexer MUX4 is an example of a fourth selector. The multiplexer MUX5 is an example of a fifth selector.

The MUX6, FF1, and MUX2 are arranged in series between the right input terminal A1R and the left output terminal A1L. The MUX6 couples either the right input terminal A1R or the output of the FF2 to the input of the FF1. The MUX2 couples either the output of the FF1 or the output of the FF2 to the multiplication input of the FMA, the left output terminal A1L, and the input of the MUX1. The path that couples the output of the MUX2 to the input of the FMA, the output terminal A1L, and the input of the MUX1 is an example of a first path.

The MUX1 and the FF2 are arranged in series between the left input terminal A2L and the right output terminal A2R. The MUX1 couples either the left input terminal A2L or the output of the MUX2 to the input of the FF2. The output of the FF2 is coupled to the right output terminal A2R, the input of the MUX6, and the input of the MUX2. The path that couples the output of the FF2 to the output terminal A2R, the input of the MUX6, and the input of the MUX2 is an example of a second path.

The FF5 is arranged between the upper input terminal BU and the lower output terminal BD. The output of the FF5 is coupled to one input of the multiplier of the FMA and to the lower output terminal BD. Note that, before the matrix multiplication starts, the data of the matrix B is sequentially transferred from an upper PE+ to a lower PE+, for example, and is retained in the FF5 of each PE+.

The MUX4, FMA, MUX5, and FF3 are arranged in series between the upper input terminal C2U and the lower output terminal C2D. The MUX4 couples either the upper input terminal C2U or the output of the FF4 to one input of the adder of the FMA. The path that couples the output of the MUX4 to the input of the FMA and the input of the MUX5 is an example of a third path. The path that couples the output of the FF4 to the output terminal C1U and the input of the MUX4 is an example of a fourth path.

The MUX3 and the FF4 are arranged in series between the lower input terminal C1D and the upper output terminal C1U. The MUX3 couples either the lower input terminal C1D or the output of the MUX5 to the input of the FF4.

The FMA multiplies the data of the matrix A output from the MUX2 by the data of the matrix B output from the FF5 using the multiplier, and outputs a result of the multiplication to another input of the adder. The addition result by the adder is output to the MUX5. The MUX5 couples either the output of the FMA or the output of the MUX4 to the input of the FF3 and to the input of the MUX3.

With the configuration described above, the PE+ may not only output the data of the matrix A retained in the FF2 to the output terminal A2R but also supply the data to the MUX2, or may cause the data to be retained in the FF1 via the MUX6. The PE+ may not only output the data of the matrix A output from the MUX2 to the output terminal A1L but also cause the data to be retained in the FF2 via the MUX1. For example, the systolic array 100 may turn the data of the matrix A transferred from the left side to the right side leftward at any PE+, and may turn the data of the matrix A transferred from the right side to the left side rightward at any PE+.

Furthermore, the PE+ may not only output the product-sum operation result by the FMA to the output terminal C2D as the data of the matrix C but also retain it in the FF4 via the MUX3. Alternatively, the PE+ may output the data of the matrix C retained in the FF4 not only to the output terminal C1U but also to the FMA and the MUX5 via the MUX4. For example, the systolic array 100 may turn the data of the matrix C transferred from the upper side to the lower side upward at any PE+, and may turn the data of the matrix C transferred from the lower side to the upper side downward at any PE+.

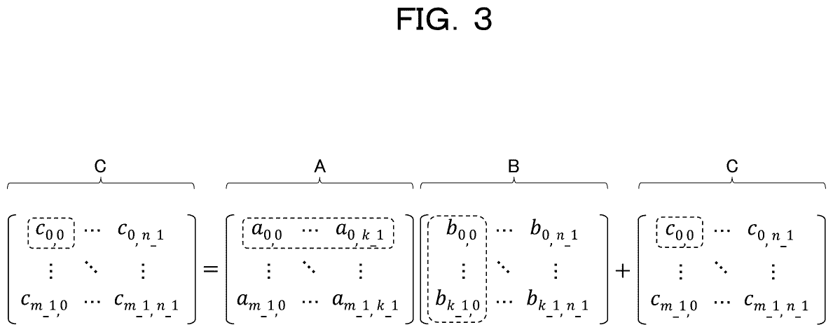

FIG. 3 illustrates exemplary matrix multiplication executed by the systolic array 100 in FIG. 1. In the example illustrated in FIG. 3, the m-by-k matrix A is multiplied by the k-by-n matrix B to obtain an m-by-n matrix product, and the m-by-n matrix C is added to the obtained matrix product to obtain a new matrix C.

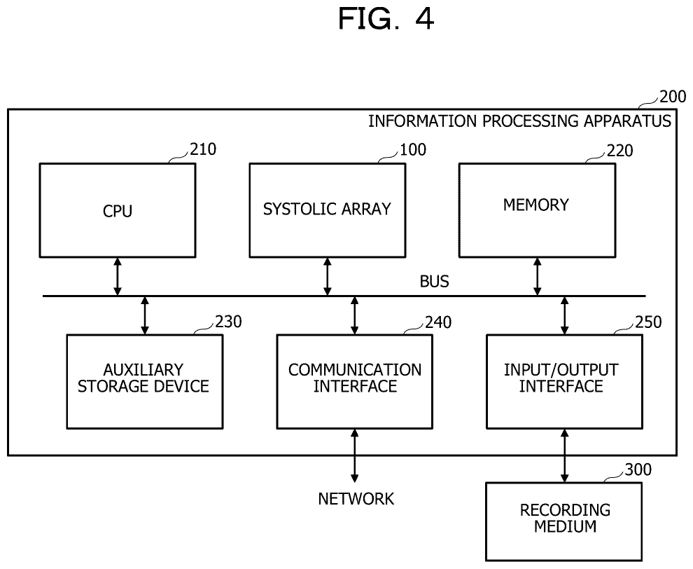

FIG. 4 illustrates an example of an information processing apparatus 200 in which the systolic array 100 in FIG. 1 is installed. For example, the information processing apparatus 200 is used for training or inference for image processing using a neural network or the like, or is used for both training and inference.

For example, the information processing apparatus 200 is a server, and includes a CPU 210, the systolic array 100, a memory 220, an auxiliary storage device 230, a communication interface 240, and an input/output interface 250, which are coupled to each other by the bus BUS, such as a memory bus. Note that the information processing apparatus 200 may include a plurality of the systolic arrays 100, or may include an element other than those illustrated. Furthermore, the systolic array 100 may be installed in the information processing apparatus 200 as an accelerator.

The CPU 210 may take overall control of the information processing apparatus 200, generate a data string (element of a matrix) for causing the systolic array 100 to execute matrix multiplication, and transfer the data string to the systolic array 100 via the bus BUS. The CPU 210 may receive a result of the matrix multiplication by the systolic array 100 via the bus BUS.

The systolic array 100 retains, in the FF, the data received from the CPU 210 or the like via the bus BUS, and executes matrix multiplication using the data retained in the FF. During the execution of the matrix multiplication, while the data of the matrix C, which is an operation result, is output from the systolic array 100 to the bus BUS, the data of the matrix A and the matrix C does not need to be input from the bus BUS to the systolic array 100.

For example, during the execution of the matrix multiplication by the systolic array 100, no data is input from the memory 220 to the systolic array 100. With this arrangement, the band of the bus BUS between the systolic array 100 and the memory 220 may be made smaller as compared with the case where the data of the matrix A and the matrix C is input to the systolic array 100 during the execution of the matrix multiplication. As a result, a decrease in operation performance caused by the band limitation of the bus BUS may be suppressed.

The memory 220 may retain target data of the matrix multiplication (matrices A, B, and C), a result of the execution of the matrix multiplication (matrix C), various programs, and the like. The auxiliary storage device 230 may retain various programs such as an operating system (OS) to be executed by the CPU 210, an information processing program for operating the information processing apparatus 200, and the like.

For example, the program stored in the auxiliary storage device 230 may be transferred to the memory 220, and may be executed by the CPU 210. Furthermore, data and various variables to be used in calculation of a neural network, which are stored in the auxiliary storage device 230, may be transferred from the auxiliary storage device 230 to the memory 220 before execution of training of the neural network or before execution of inference using the neural network.

For example, the communication interface 240 may have a function of communicating with another information processing apparatus or the like via a network. With this arrangement, a plurality of information processing apparatuses may be used to execute the calculation of the neural network in parallel. The input/output interface 250 may have a function of inputting/outputting data, a program, or the like to/from a recording medium 300 coupled to the information processing apparatus 200. The program recorded in the recording medium 300 may be transferred to the auxiliary storage device 230 via the input/output interface 250, and then loaded into the memory 220 for execution by the CPU 210.

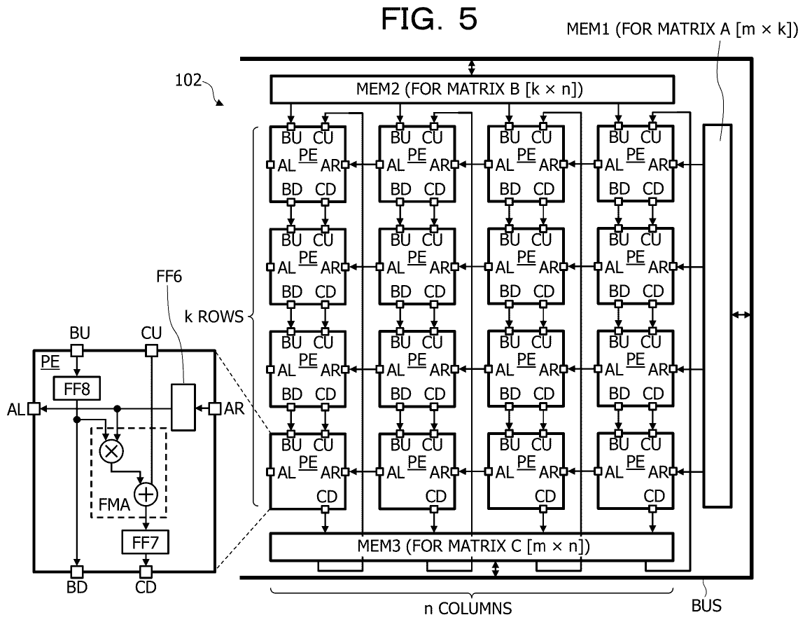

FIG. 5 illustrates an example of another systolic array matrix multiplier. A systolic array matrix multiplier 102 illustrated in FIG. 5 includes 16 processing elements PE of 4 rows and 4 columns, and is coupled to a memory MEM1 for the matrix A, a memory MEM2 for the matrix B, and a memory MEM3 for the matrix C. Hereinafter, the systolic array matrix multiplier 102 will also be referred to as a systolic array 102, and the processing element PE will also be referred to as a PE. Note that the systolic array 102 may have k rows and n columns.

For example, the memories MEM1, MEM2, and MEM3 may be scratchpad memories. The memory MEM1 retains each piece of data of the m-by-k matrix A in advance, the memory MEM2 retains each piece of data of the k-by-n matrix B in advance, and the memory MEM3 retains each piece of data of the m-by-n matrix C in advance.

Each PE includes an FF6, FF7, FF8, and FMA. Each of the FF6, FF7, and FF8 may retain one element of the matrix. Note that, unlike the PE+ illustrated in FIG. 2, the PE does not have a path for transferring the data of the matrix A from the left side to the right side and a path for transferring the data of the matrix C from the lower side to the upper side.

The FF6 retains the data of the matrix A received by an input terminal AR, and outputs the retained data to the FMA and to an output terminal AL. The FF7 retains an operation result by the FMA, and outputs the retained operation result to an output terminal CD. An input terminal CU receives the data of the matrix C. The FF8 retains the data of the matrix B received by the input terminal BU, and outputs the retained data to the FMA and to the output terminal BD.

In the four PEs in each row, the data of the matrix A read from the memory MEM1 arranged on the right side of the systolic array 102 is sequentially transferred from the PE on the right side toward the PE on the left side, and is retained in the FF6. In the four PEs in each column, the data of the matrix B read from the memory MEM2 arranged on the upper side of the systolic array 102 is sequentially transferred from the PE on the upper side toward the PE on the lower side, and is retained in the FF8. Furthermore, in the four PEs in each column, the data of the matrix C read from the memory MEM3 arranged on the lower side of the systolic array 102 is sequentially transferred from the PE on the upper side toward the PE on the lower side, and is input to each FMA. The product-sum operation result by the FMA is retained in the FF7.

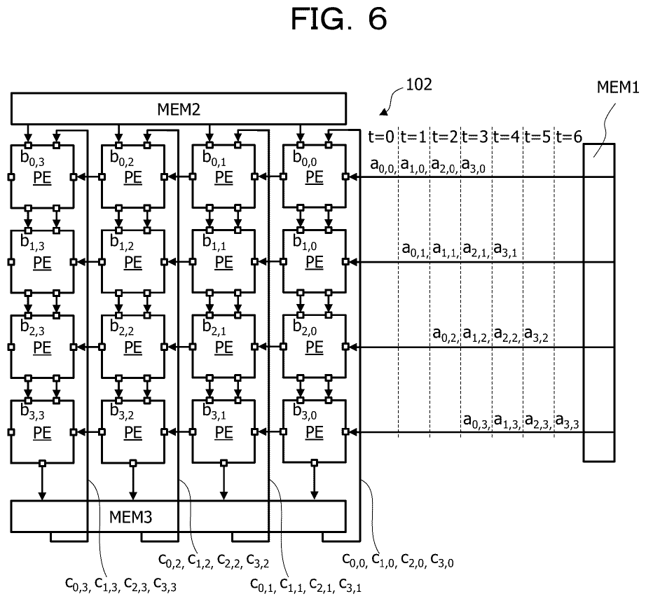

FIG. 6 illustrates an outline of operation of the systolic array matrix multiplier 102 in FIG. 5. Before the matrix multiplication is executed, 16 pieces of data a, 16 pieces of data b, and 16 pieces of data c included in the matrices A, B, and C of the matrix multiplication to be executed are stored in advance in the memories MEM1, MEM2, and MEM3, respectively.

First, the data of the matrix B stored in the memory MEM2 is transferred in a bucket brigade manner between the flip-flops FF8 (FIG. 5) of the PEs arranged in the vertical direction each one clock, and the FF8 of each PE retains any of data B0,0 to B3,3 of the matrix B.

Next, the data of the matrix A stored in the memory MEM1 is transferred in a bucket brigade manner for each row of the PE while being shifted by one clock, and the data of the matrix C stored in the memory MEM3 is transferred in a bucket brigade manner for each column of the PE while being shifted by one clock. For example, in a clock cycle t=0 to 3, the data of the matrix A is sequentially transferred to the uppermost row of the PE in FIG. 6, and the data of the matrix C is sequentially transferred to the rightmost column in FIG. 6. Likewise, in a clock cycle t=1 to 4, the data of the matrix A is sequentially transferred to the second row of the PE from the top in FIG. 6, and the data of the matrix C is sequentially transferred to the second column from the right in FIG. 6.

Each PE multiplies one element of the matrix A by one element of the matrix B, adds a result of the multiplication to the element of the matrix C, which is a partial sum transferred from the PE one above, and transfers a result of the addition to the PE one below. For example, in a case where there are k pieces of PE in the column direction, when the data of the matrix C_{i,j} input from the top of the systolic array 102 is output from the lowermost PE, C_{i,j}=C_{i,j}+Σ(K=0, 1, . . . , k−1)a_{i,K}×b_{K,j} is stored in the memory MEM3 for the matrix C.

Note that, in a case where four matrix multiplications of two rows and two columns ((m, n, k)=(2, 2, 2)) are executed in the systolic array 102, the matrix multiplication is executed four times using four pieces of PE of two rows and two columns among the 16 pieces of PE. The FMA of the PE not used for the matrix multiplication executes a useless operation (0×0+0).

For example, in a case of executing the two-by-two matrix multiplication using a systolic array including four pieces of PE of two rows and two columns, an operation result may be output in four clock cycles. On the other hand, in the two-by-two matrix multiplication using the systolic array 102, six clock cycles same as the processing time of the four-by-four matrix multiplication are needed.

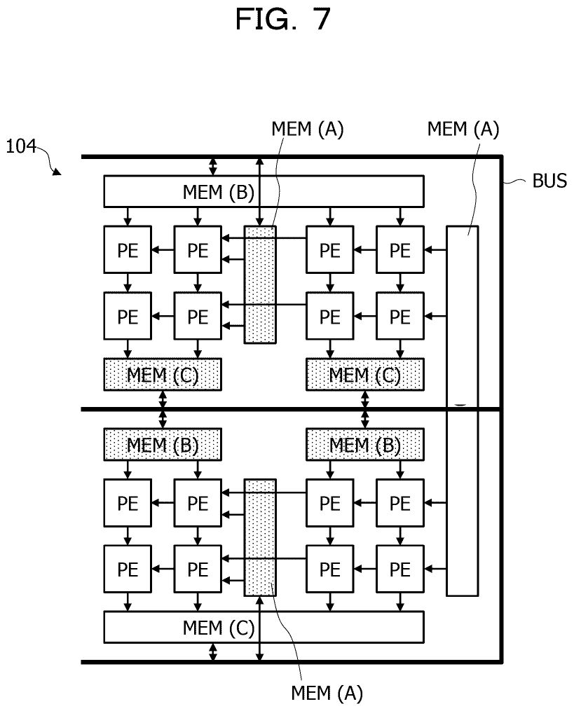

FIG. 7 illustrates an example of still another systolic array matrix multiplier. A systolic array matrix multiplier 104 illustrated in FIG. 7 enables both the four-by-four matrix multiplication using 16 pieces of PE and the four two-by-two matrix multiplications using four pieces of PE, and thus a memory MEM is assigned for each PE of two rows and two columns. Reference signs A, B, and C assigned to memories MEM indicate that the memories MEM retains the matrices A, B, and C, respectively. Hereinafter, the systolic array matrix multiplier 104 will also be referred to as a systolic array 104.

As compared with the systolic array 102 in FIG. 5, memories MEM, which are shaded, need to be added to the systolic array 104, and a mounting area of the memory and wiring between the PE and the bus BUS increase. Note that the systolic array 104 may execute each of the four-by-four matrix multiplication and the two-by-two matrix multiplication in the shortest processing time.

Moreover, for example, in a case where a systolic array including 64 pieces of PE in an eight-by-eight matrix is used to enable execution of one eight-by-eight, four four-by-four, and 16 two-by-two matrix multiplications, the mounting area of the memory MEM and the wiring between the PE and the bus BS further increase. As the number of pieces of PE mounted increases, the mounting area of the memory MEM and the wiring between the PE and the bus BUS increase, and thus the systolic array 104 is not practical.

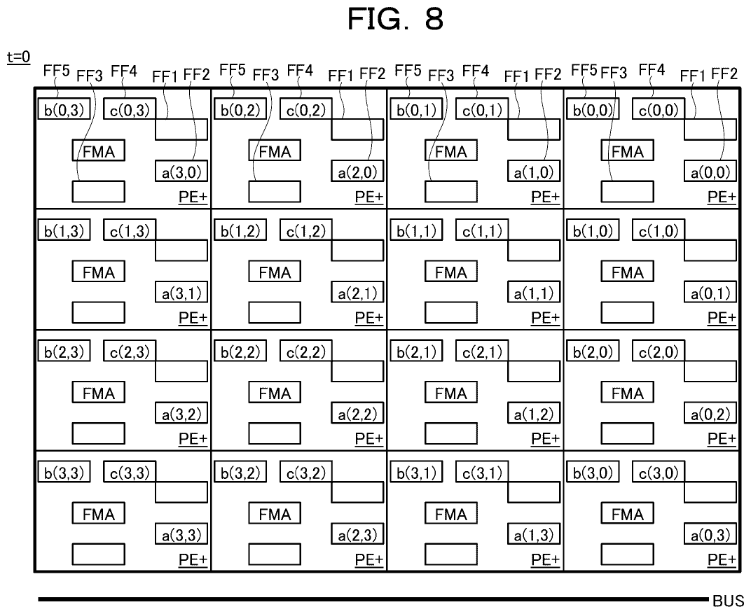

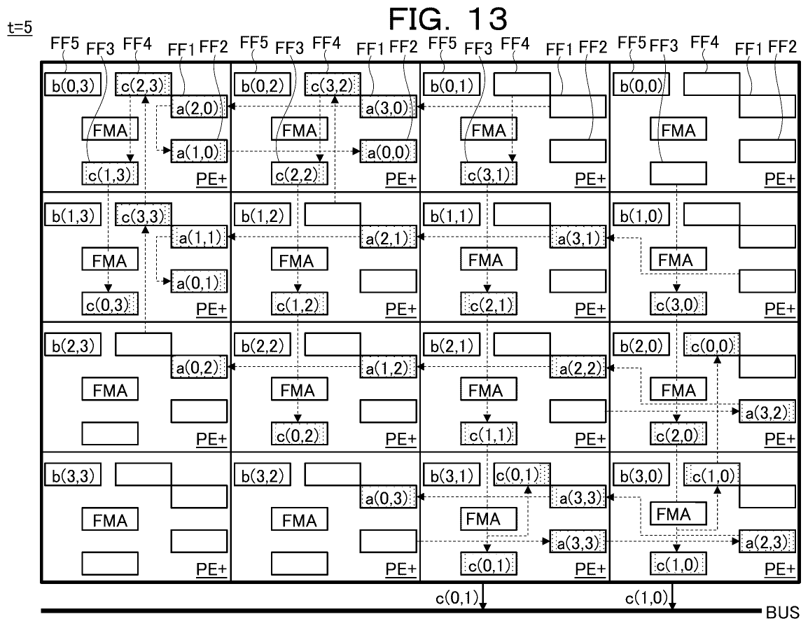

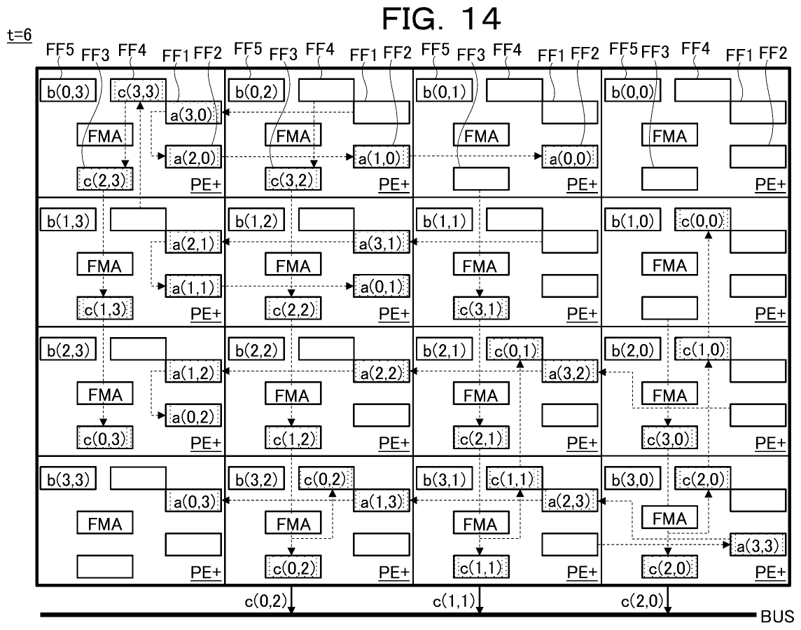

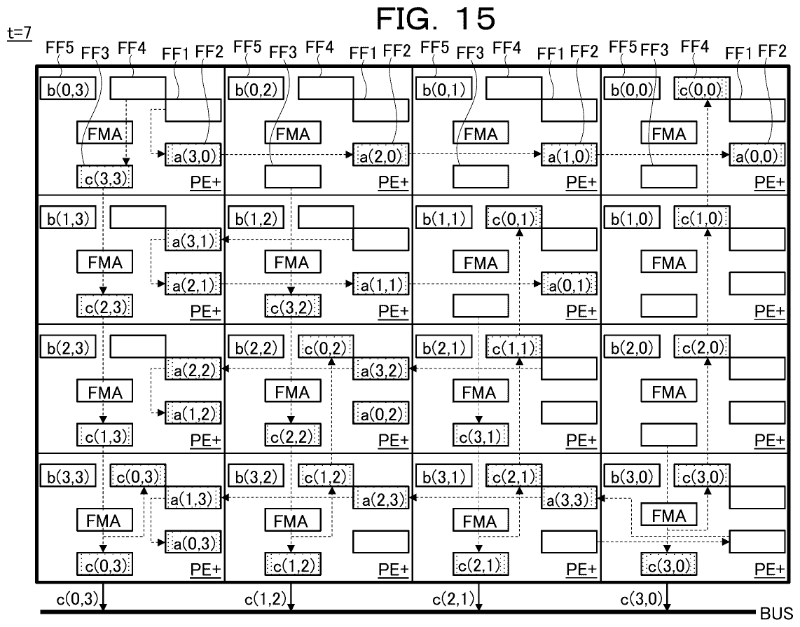

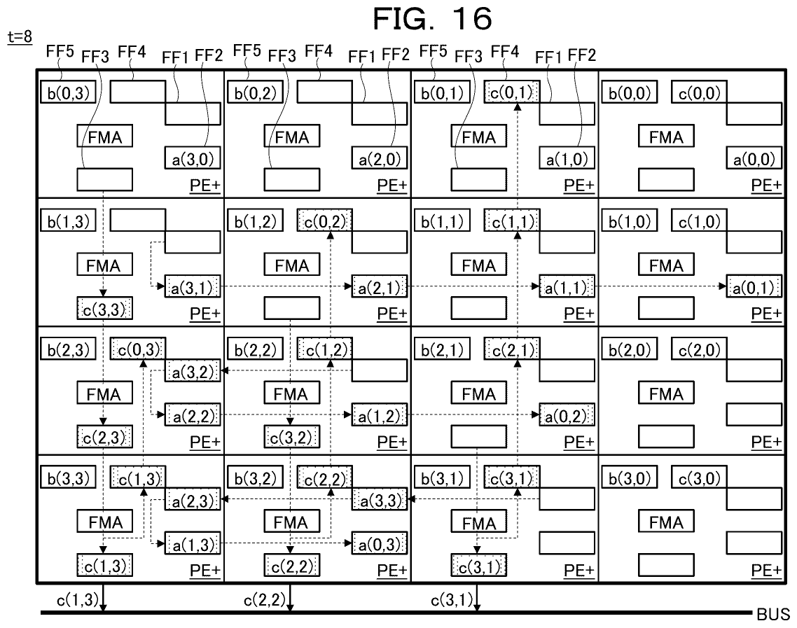

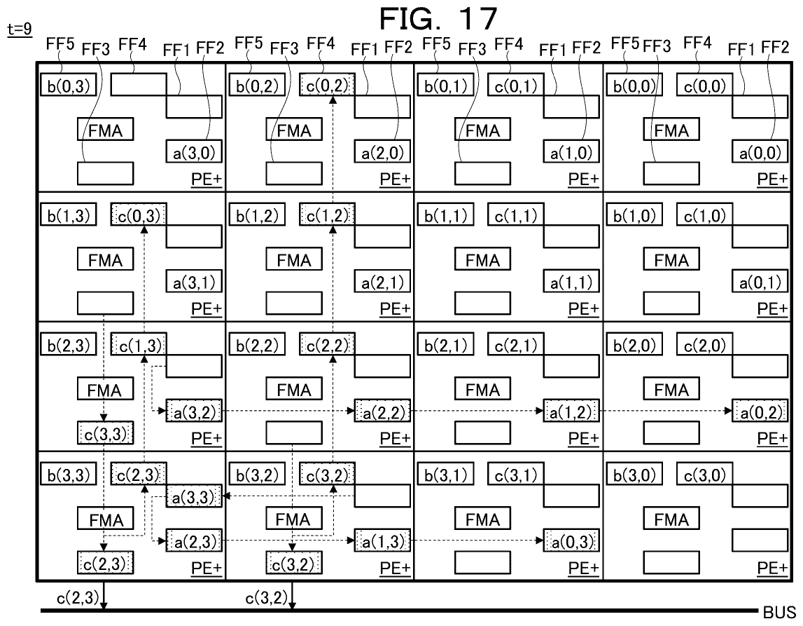

FIGS. 8 to 18 illustrate exemplary operation of the systolic array matrix multiplier 100 in FIG. 1. For example, FIGS. 8 to 18 illustrate an exemplary case where the four-by-four matrix multiplication C=A×B+C is executed once. FIGS. 8 to 18 illustrate only the FF and the FMA, and the paths of the data of the matrices A, B, and C input to the FMA and the output path of the FMA are omitted. A reference sign t indicates a clock cycle. Furthermore, since the data c of the matrix C sequentially adds the multiplication results of the data a and b, a data value is sequentially updated.

The 16 elements of the matrix A are indicated by a(3, 0) to a(0, 0), a(3, 1) to a(0, 1), a(3, 2) to a(0, 2), and a(3, 3) to a(0, 3) in order from the top row. The 16 elements of the matrix B are indicated by b(0, 0) to b(3, 0), b(0, 1) to b(3, 1), b(0, 2) to b(3, 2), and b(0, 3) to b(3, 3) in order from the right column. The 16 elements of the matrix C are indicated by c(0, 0) to c(3, 0), c(0, 1) to c(3, 1), c(0, 2) to c(3, 2), and c(0, 3) to c(3, 3) in order from the right column.

FIG. 8 (clock cycle t=0) illustrates an initial state in which the data of the matrices A, B, and C are retained in the FF2, FF5, and FF4 of each PE+, respectively. Data illustrated in a frame of each FF indicates that the data is retained in each FF and is output from each FF. After FIG. 8, no data is input/output between the systolic array 100 and the bus BUS except for the output of the operation result of the FMA to the bus BUS.

Hereinafter, descriptions will be given also with reference to FIG. 2. The PE+ in the rightmost column at which the elements of the matrix A are turned leftward selects the input terminal A2L using the multiplexer MUX1, and selects the output of the FF2 using the multiplexer MUX2. The PE+ in the leftmost column at which the elements of the matrix A are turned rightward selects the output of the FF1 using the multiplexer MUX2, and selects the output of the multiplexer MUX2 using the multiplexer MUX1.

The PE+ in the uppermost row at which the elements of the matrix C are turned downward selects the input terminal C1D using the multiplexer MUX3, selects the output of the FF4 using the multiplexer MUX4, and selects the output of the FMA using the multiplexer MUX5. The PE+ in the lowermost row at which the elements of the matrix C are turned upward selects the input terminal C2U using the multiplexer MUX4, selects the output of the FMA using the multiplexer MUX5, and selects the output of the multiplexer MUX5 using the multiplexer MUX3.

The center PE+ not adjacent to the right end, left end, upper end, and lower end selects the input terminal A1R using the multiplexer MUX6, selects the output of the FF1 using the multiplexer MUX2, and selects the input terminal A2L using the multiplexer MUX1. Furthermore, the center PE+ selects the input terminal C2U using the multiplexer MUX4, selects the output of the FMA using the multiplexer MUX5, and selects the input terminal C1D using the multiplexer MUX3.

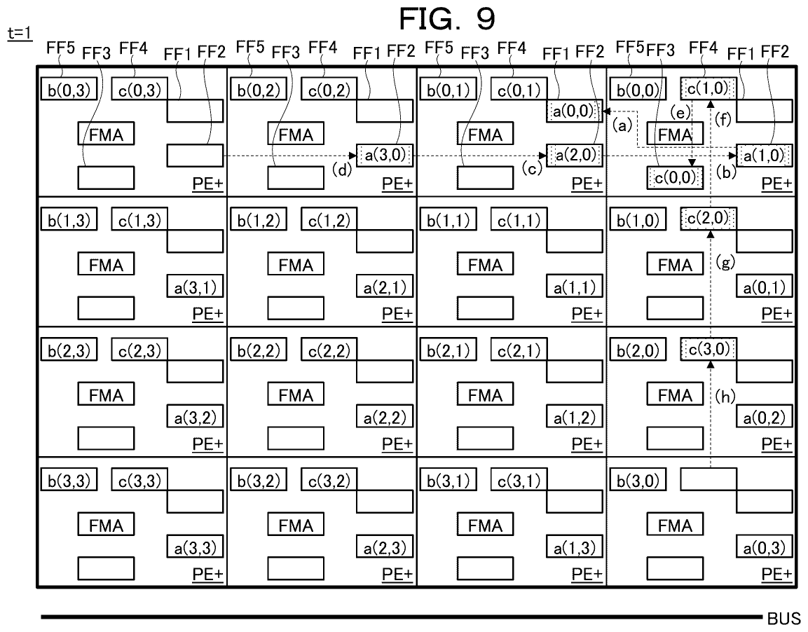

Dashed arrows illustrated in FIGS. 9 to 18 indicate that data is transferred from a transfer source to a transfer destination. The shaded FF in FIGS. 9 to 18 indicates that data is newly retained. An addition result obtained by adding the multiplication result of the FMA and the data c is indicated as data C.

In FIG. 9 (clock cycle t=1), the data a(0, 0) of the PE+ in the uppermost row is transferred to the PE+ one left, and the data a(1, 0), a(2, 0), a(3, 0) are transferred to the PE+ one right ((a), (b), (c), and (d) in FIG. 9). Furthermore, in the upper right PE+, the data c(0, 0) output from the FF4 is added to the multiplication result, and the addition result is stored in the FF3 as the data c(0, 0) ((e) in FIG. 9). The data c(1, 0), c(2, 0), and c(3, 0) of the PE+ in the rightmost column are transferred to the PE+ one above ((f), (g), and (h) in FIG. 9).

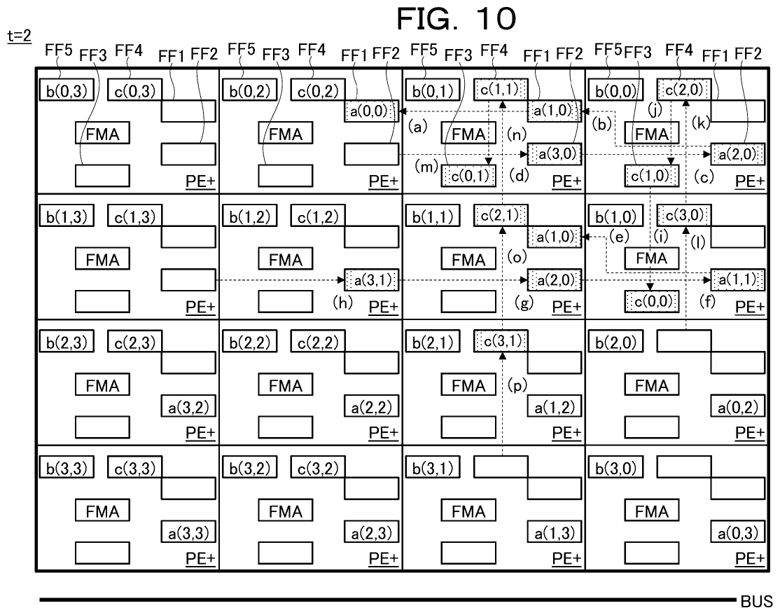

In FIG. 10 (clock cycle t=2), the data a(0, 0) and a(1, 0) of the PE+ in the uppermost row is transferred to the PE+one left, and the data a(2, 0) and a(3, 0) are transferred to the PE+ one right ((a), (b), (c), and (d) in FIG. 10). The data a(1, 0) of the PE+ in the second row from the top is transferred to the PE+ one left, and the data a(1, 1), a(2, 1), and a(3, 1) are transferred to the PE+ one right ((e), (f), (g), and (h) in FIG. 10).

Furthermore, the data c(0, 0) of the upper right PE+ is added to the multiplication result of the PE+ one below, and the addition result is stored in the FF3 as c(0, 0) ((i) in FIG. 10). The data c(1, 0) of the upper right PE+ is added to the multiplication result, and the addition result is stored in the FF3 as c(1, 0) ((j) in FIG. 10). The data c(2, 0) and c(3,0) of the PE+ in the rightmost column are transferred to the PE+ one above (k) and (l) in FIG. 10).

In the uppermost PE+ in the second column from the right, the data c(0, 1) is added to the multiplication result, and the addition result is stored in the FF3 as data c(0, 1) ((m) in FIG. 10). The data c(1, 1), c(2, 1), and c(3, 1) of the PE+ in the second column from the right are transferred to the PE+ one above ((n), (o), and (p) in FIG. 10).

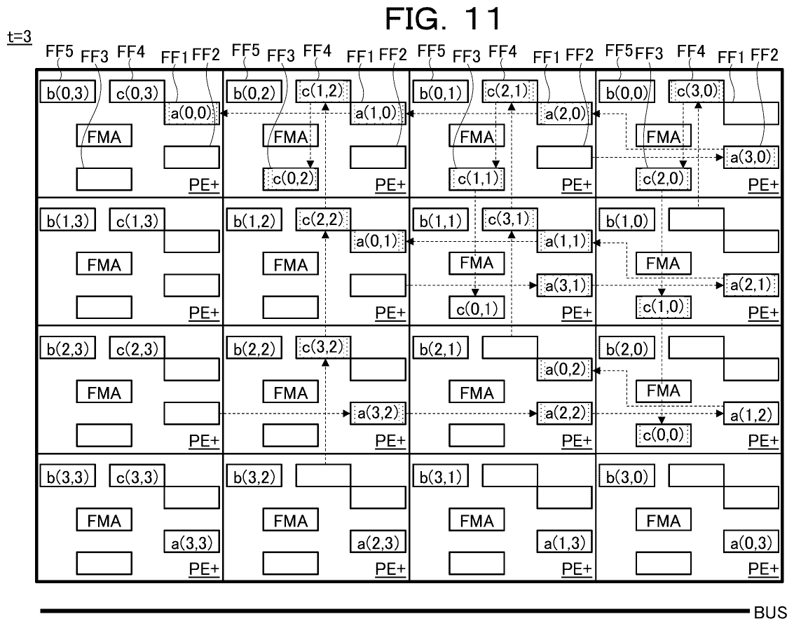

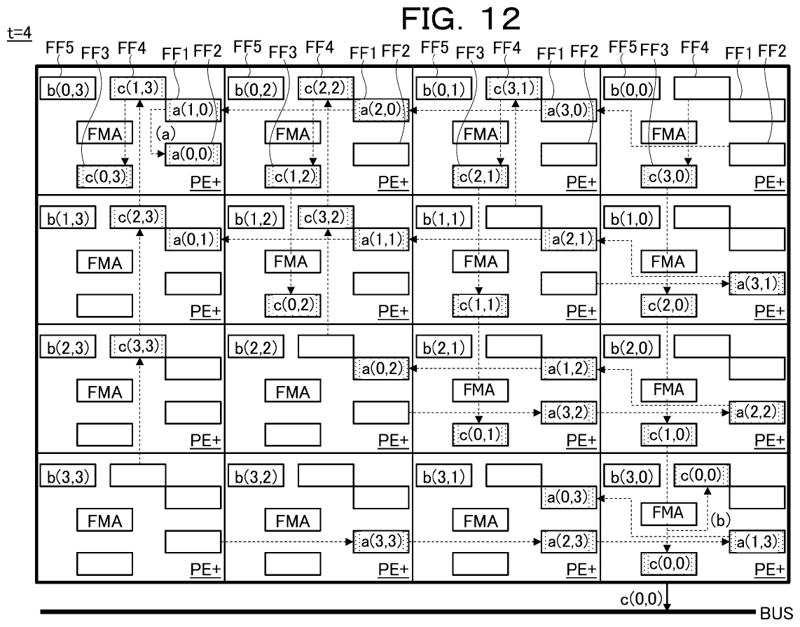

Also in FIGS. 11 (clock cycle t=3) to 18 (clock cycle t=10), in a similar manner to FIGS. 9 and 10, the data a in each row is transferred to the PE+ one right, and then turned and transferred to the PE+one left. Note that, in FIG. 12, for example, the data a(0, 0) retained in the FF1 of the upper left PE+ is transferred to the FF2 ((a) in FIG. 12). As a result, the elements of the matrix A sequentially transferred from the right side to the left side in FIG. 12 may be turned in the systolic array 100 and sequentially transferred to the PE+ on the right side.

The data c in each column is transferred to the PE+ one above, and then turned at the uppermost PE+ and added by the FMA, and the addition result is stored in the FF3 as data c. The addition result stored in the FF3 is transferred to the PE+ one below in the next clock cycle, and is added by the FMA. In FIGS. 12 (clock cycle t=4) to 18 (clock cycle t=10), the matrix multiplication result retained in the FF3 in the PE+ in the lowermost row is sequentially output to the bus BUS in order from the PE+ on the right side.

Note that the multiplexer MUX3 (FIG. 2) of the PE+ in the lowermost row selects the output of the multiplexer MUX5. As a result, in the lower right PE+ in FIG. 12, for example, the matrix multiplication result c(0, 0) may be retained also in the FF4, and the elements of the matrix C as the matrix multiplication result may be turned in the systolic array 100 and sequentially transferred to the PE+ on the upper side ((b) in FIG. 12).

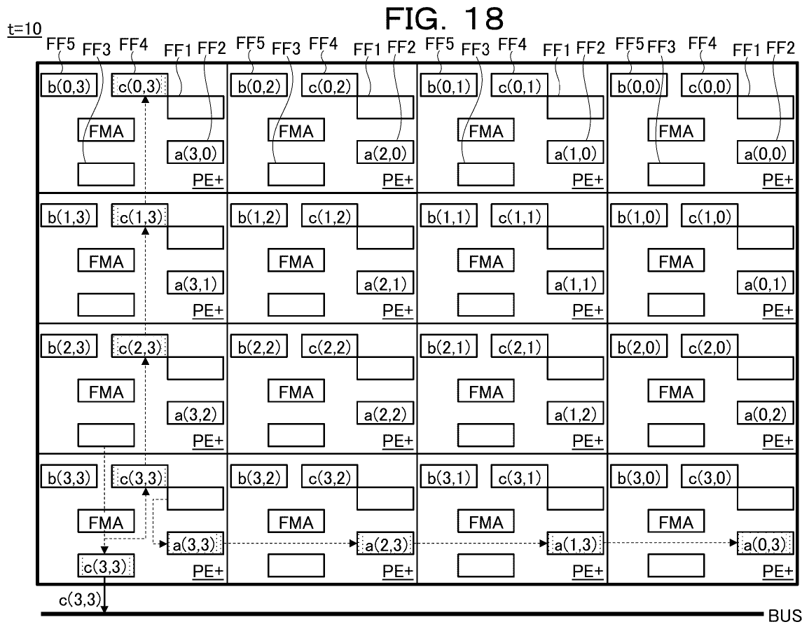

Then, in FIG. 18, the data a and c retained in each PE+ return to the state of the clock cycle t=0 in FIG. 8. The data b is retained in the same state as the clock cycle t=0. As a result, the next matrix multiplication may be started without re-inputting the data a, b, and c from the bus BUS to each PE+, whereby an increase in the band of the bus BUS may be suppressed.

As illustrated in FIGS. 8 to 18, by turning the data a at the rightmost PE+, the data a may be supplied to each PE+ without using the bus BUS during the execution of the matrix multiplication. Furthermore, by turning the data c at the uppermost PE+, the data c may be supplied to each PE+ without using the bus BUS during the execution of the matrix multiplication. As a result, for example, the band of the bus BUS may be made smaller as compared with the case of inputting the data a and c to the systolic array 100 via the bus BUS while performing the matrix multiplication.

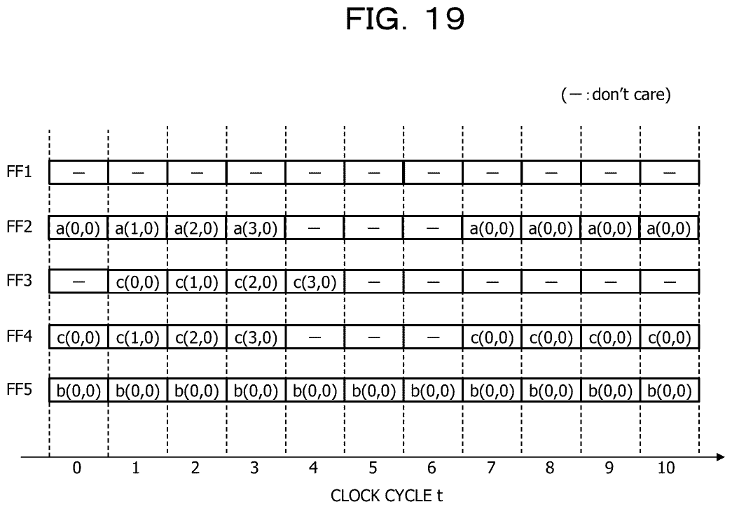

FIG. 19 illustrates an example of individual values output from the FF1 to FF5 of the upper right PE+ in the systolic array 100 in FIG. 1. The FF1 of the upper right PE+ is used at the time of inputting the data a into the PE+ via the bus BUS, and is not used during the execution of the matrix multiplication. In the clock cycles t=0 to t=3, the FF2 sequentially retains the data a(0, 0), a(1, 0), a(2, 0), and a(3, 0) to be used for the product-sum operation, and outputs the data to the FMA. Furthermore, in the clock cycle t=7, the FF2 retains the data a(0, 0) turned from the PE+ on the right side, and continues to retain the data until the clock cycle t=10.

In the clock cycles t=1 to t=4, the FF3 sequentially retains the data c(0, 0), c(1, 0), c(2, 0), and c(3, 0), which are product-sum operation results, and outputs the data to the PE+ one below. In the clock cycles t=0 to t=3, the FF4 sequentially retains the data c(0, 0), c(1, 0), c(2, 0), and c(3, 0) to be used for the product-sum operation, and outputs the data to the FMA. Furthermore, in the clock cycle t=7, the FF4 retains the data c(0, 0), which is the product-sum operation result, and continues to retain the data until the clock cycle t=10. The FF5 continues to retain the data b(0, 0) without transferring it.

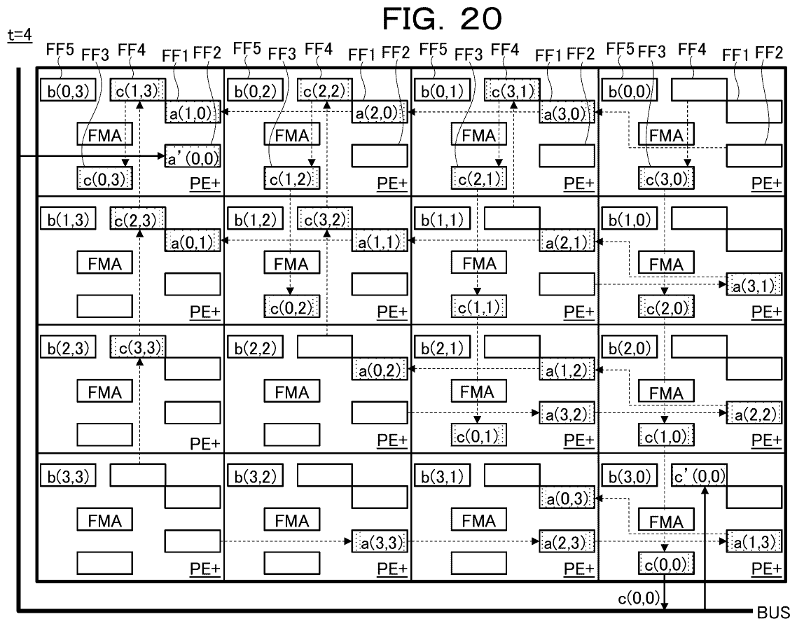

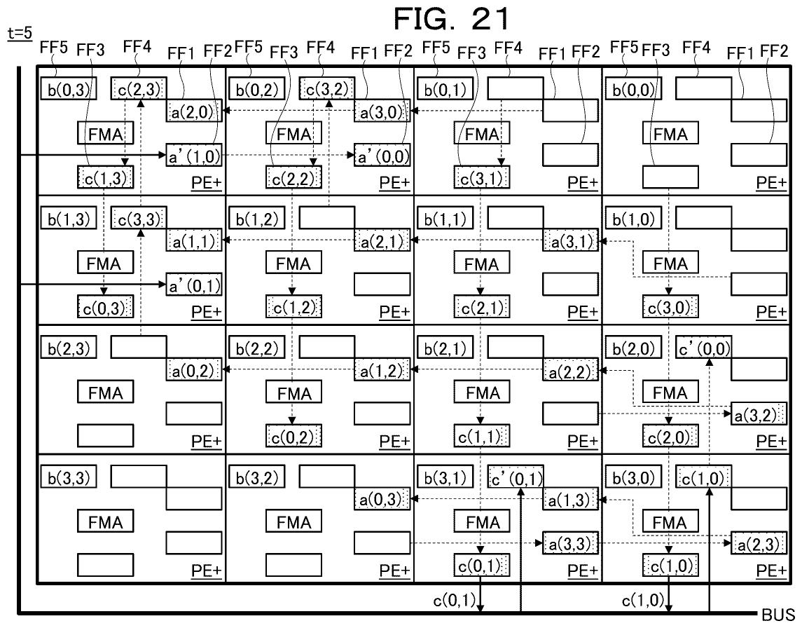

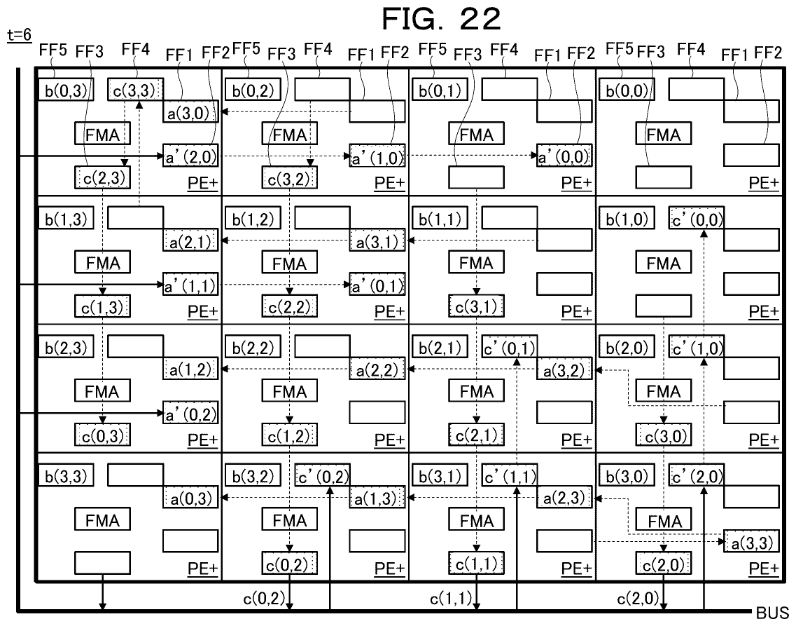

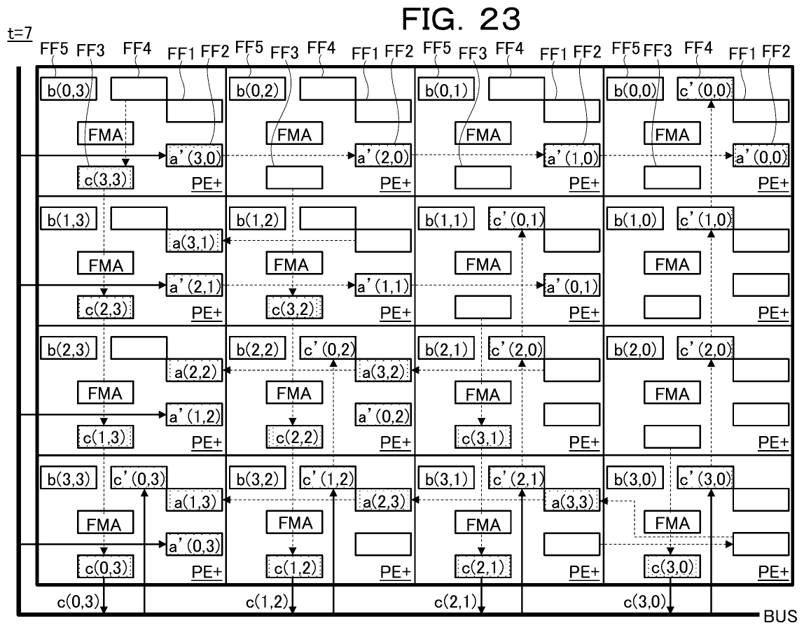

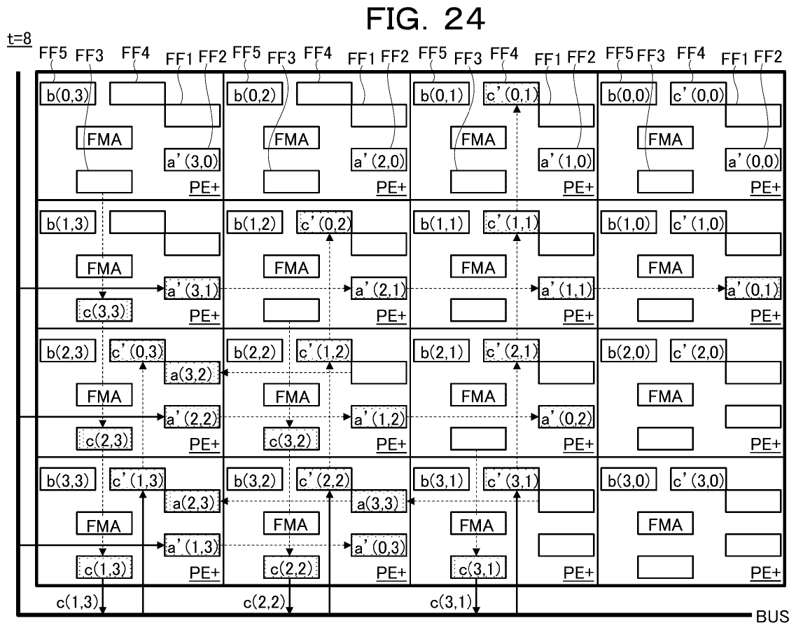

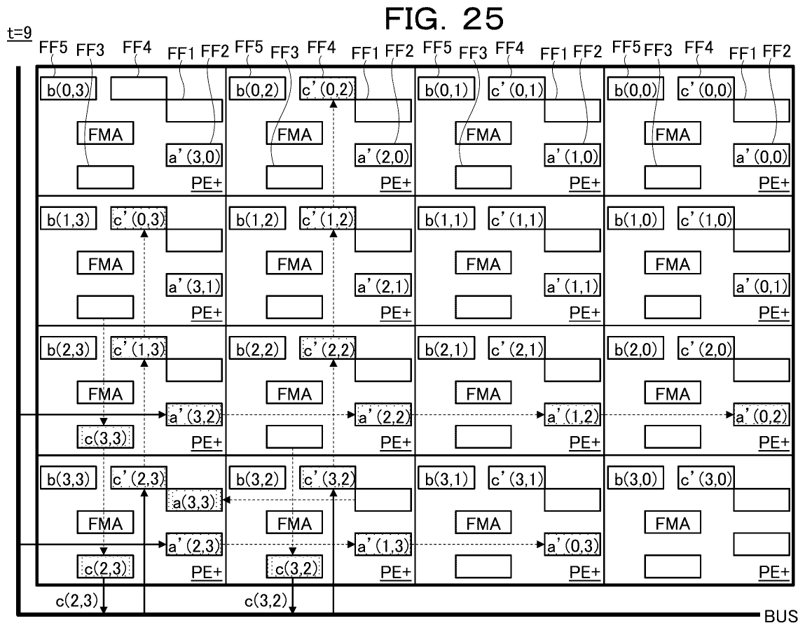

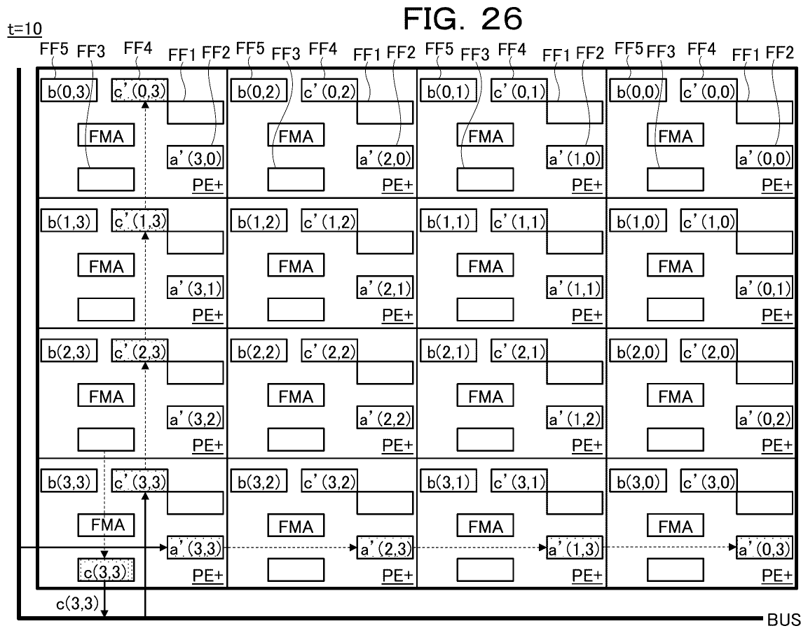

FIGS. 20 to 26 illustrate another exemplary operation of the systolic array matrix multiplier 100 in FIG. 1. FIGS. 20 to 26 illustrate an exemplary case of importing data of matrices A′ and C′ into the systolic array 100 at a time of executing, after executing four-by-four matrix multiplication C=A ×B+C, another four-by-four matrix multiplication C′=A′×B+C′ with the value of the matrix B in common. FIGS. 20 to 26 illustrate operations at and after the time t=4 following the clock cycle t=3 in FIG. 11. The operation in the clock cycles t=0 to t=3 is the same as that in FIGS. 8 to 11.

In the clock cycle t=4 to t=7, data a′(0, 0), a′(1, 0), a′(2, 0), and a′(3, 0) are sequentially input to the PE+ in the uppermost row, and are retained in the FF2 of each PE+. In the clock cycles t=5 to t=8, data a′(0, 1), a′(1, 1), a′(2, 1), and a′(3, 1) are sequentially input to the PE+ in the second row from the top, and are retained in the FF2 of each PE+.

In the clock cycles t=6 to t=9, data a′(0, 2), a′(1, 2), a′(2, 2), and a′(3, 2) are sequentially input to the PE+ in the third row from the top, and are retained in the FF2 of each PE+. In the clock cycles t=7 to t=10, data a′(0, 3), a′(1, 3), a′(2, 3), and a′(3, 3) are sequentially input to the PE+ in the lowermost row, and are retained in the FF2 of each PE+.

In the clock cycles t=4 to t=7, data c′(0, 0), c′(1, 0), c′(2, 0), and c′(3, 0) are sequentially input to the PE+ in the rightmost column, and are retained in the FF4 of each PE+. In the clock cycles t=5 to t=8, data c′(0, 1), c′(1, 1), c′(2, 1), and c′(3, 1) are sequentially input to the PE+ in the second column from the right, and are retained in the FF4 of each PE+.

In the clock cycles t=6 to t=9, data c′(0, 2), c′(1, 2), c′(2, 2), and c′(3, 2) are sequentially input to the PE+ in the third column from the right, and are retained in the FF4 of each PE+. In the clock cycles t=7 to t=10, data c′(0, 3), c′(1, 3), c′(2, 3), and c′(3, 3) are sequentially input to the PE+ in the lowermost row, and are retained in the FF4 of each PE+.

As illustrated in FIGS. 20 to 26, during the matrix multiplication, the systolic array 100 may also input the data a′ and the data c′ to be used in the next matrix multiplication to each PE+ via the bus BUS. As a result, usability of the systolic array 100 may improve.

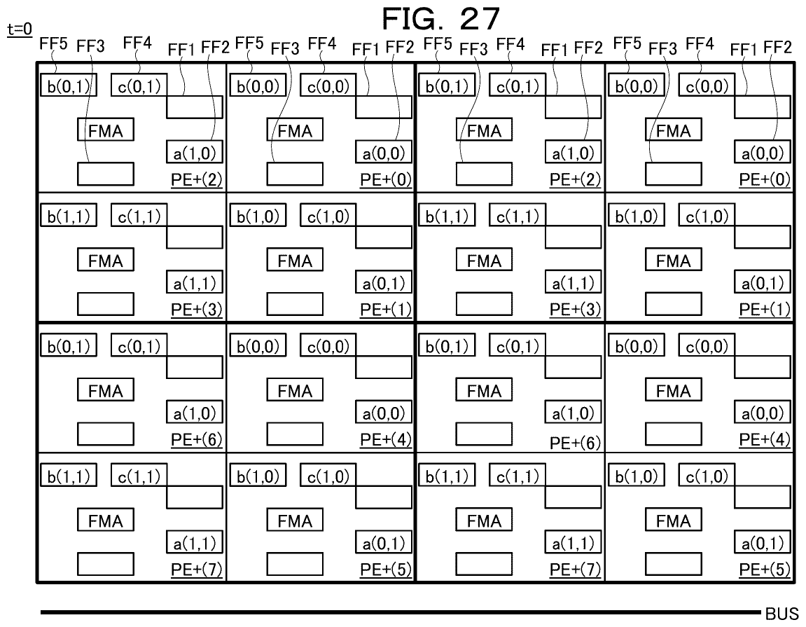

FIGS. 27 to 33 illustrate exemplary operation in a case of executing four two-by-two matrix multiplications in parallel by dividing the systolic array 100 in FIG. 1 into four parts of two rows and two columns. Detailed descriptions of operations similar to those in FIGS. 8 to 18 will be omitted. Hereinafter, a systolic array including four pieces of PE+ of two rows and two columns will be referred to as a subarray.

FIGS. 27 to 33 illustrate an exemplary case where each subarray executes two-by-two matrix multiplication C=A×B+C once and transfers the multiplication result to the bus BUS. The multiplication results of the upper two subarrays are transferred to the bus BUS through the lower two subarrays. The initial states of the data a, b, and c of the matrices A, B, and C retained in the four pieces of PE+ of each subarray (clock cycle t=0 in FIG. 27) are similar to those of the data a, b, and c of the matrices A, B, and C retained in the four pieces of PE+ in the upper right of FIG. 8.

Each subarray executes matrix multiplication using the data a(0, 0), a(1, 0), a(0, 1), and a(1, 1) of the matrix A, the data b(0, 0), b(1, 0), b(0, 1), and b(1, 1) of the matrix B, and the data c(0, 0), c(1, 0), c(0, 1), and c(1, 1) of the matrix C. Note that the data values of the matrix A used by the four subarrays in the matrix multiplication may be different from each other. The data values of the matrix B used by the four subarrays in the matrix multiplication may be different from each other. The data of the matrix C used by the four subarrays in the matrix multiplication may be different from each other.

The operation of the left two subarrays is the same as the operation of the right two subarrays. Thus, the operation of the right two subarrays will be described below. Furthermore, identification numbers (0) to (7) will be assigned to the eight pieces of PE+ included in the two subarrays on the right side and on the left side to simplify descriptions.

The operation of the upper subarray and the operation of the lower subarray are similar to each other except that a part of the operation of the PE+ in the lower row of each subarray is different. For example, the upper subarray turns and retains the product-sum operation results of the PE+(1) and PE+(3) while outputting them to the lower subarray. On the other hand, the lower subarray turns and retains the product-sum operation results of the PE+(7) and PE+(5) while outputting them to the bus BUS.

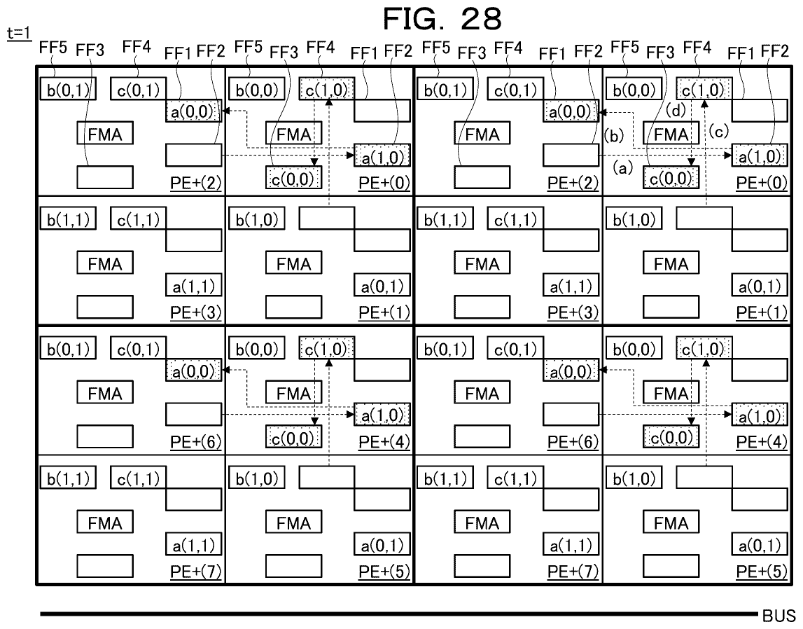

In FIG. 28 (clock cycle t=1), the data a(1, 0) retained in the FF2 of the PE+(2) is transferred to the FF2 of the PE+(0) ((a) in FIG. 28). The data a(0, 0) retained in the FF2 of the PE+(0) is transferred to the FF1 of the PE+(2) ((b) in FIG. 28). The data c(1, 0) retained in the FF4 of the PE+(1) is transferred to the FF4 of the PE+(0) ((c) in FIG. 28). The data c(0, 0) retained in the FF4 of the PE+(0) is added to the multiplication result of the PE+(0), and the addition result is stored in the FF2 of the PE+(0) as data c(0, 0) ((d) in FIG. 28). Operations of the PE+(4), PE+(5), and PE+(6) are similar to the operations of the PE+(0), PE+(1), and PE+(2).

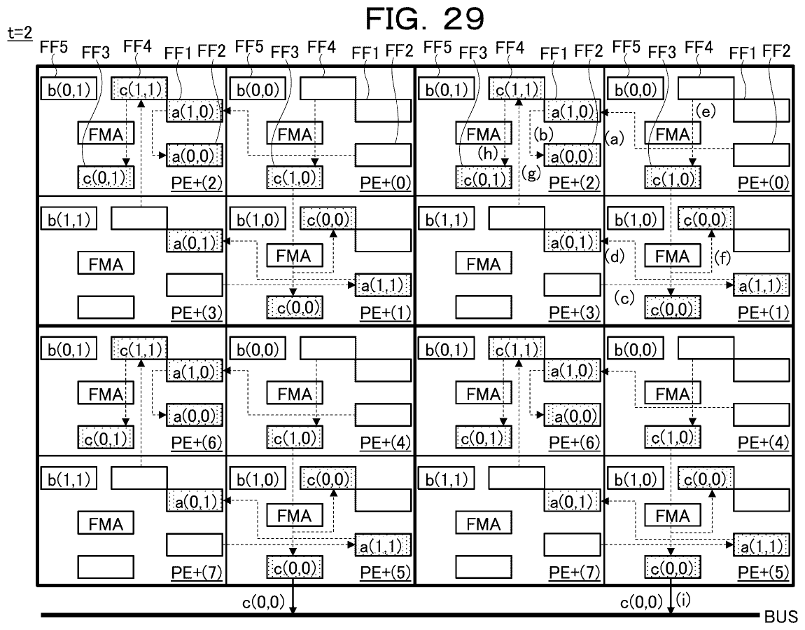

In FIG. 29 (clock cycle t=2), the data a(1, 0) retained in the FF2 of the PE+(0) is transferred to the FF1 of the PE+(2) ((a) in FIG. 29). The data a(0, 0) retained in the FF1 of the PE+(2) is transferred to the FF2 of the PE+(2) ((b) in FIG. 29). The data a(1, 1) retained in the FF2 of the PE+(3) is transferred to the FF2 of the PE+(1) ((c) in FIG. 29). The data a(0, 1) retained in the FF2 of the PE+(1) is transferred to the FF1 of the PE+(3) ((d) in FIG. 29).

The data c(1, 0) retained in the FF4 of the PE+(0) is added to the multiplication result of the PE+(0), and the addition result is stored in the FF3 of the PE+(0) as data c(1, 0) ((e) in FIG. 29). The data c(0, 0) retained in the FF2 of the PE+(0) is added to the multiplication result of the PE+(1), and the addition result is stored in the FF3 and FF4 of the PE+(1) as data c(0, 0) ((f) in FIG. 29).

The data c(1, 1) retained in the FF4 of the PE+(3) is transferred to the FF4 of the PE+(2) ((g) in FIG. 29). The data c(0, 1) retained in the FF4 of the PE+(2) is added to the multiplication result of the PE+(2), and the addition result is stored in the FF2 of the PE+(2) as data c(0, 1) ((h) in FIG. 29). Operations of the PE+(4) to PE+(7) are similar to the operations of the PE+(0) to PE+(3) except that the data c(0, 0), which is the product-sum operation result of the PE+(5), is not only stored in the FF3 and FF4 but also output to the bus BUS ((i) in FIG. 29).

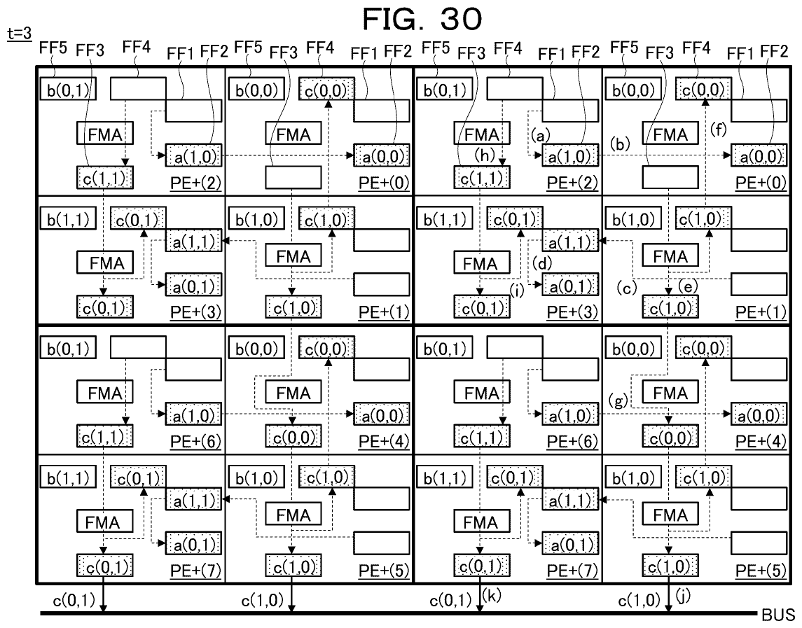

In FIG. 30 (clock cycle t=3), the data a(1, 0) retained in the FF1 of the PE+(2) is transferred to the FF2 of the PE+(2) ((a) in FIG. 30). The data a(0, 0) retained in the FF2 of the PE+(2) is transferred to the FF2 of the PE+(0) ((b) in FIG. 30). As a result, the FF2 of the PE+(0) and PE+(2) returns to the initial state of retaining the data a(0, 0) and a(1, 0), respectively.

The data a(1, 1) retained in the FF2 of the PE+(1) is transferred to the FF1 of the PE+(3) ((c) in FIG. 30). The data a(0, 1) retained in the FF1 of the PE+(3) is transferred to the FF2 of the PE+(3) ((d) in FIG. 30).

The data c(1, 0) retained in the FF3 of the PE+(0) is added to the multiplication result of the PE+(1), and the addition result is stored in the FF3 and FF4 of the PE+(1) as data c(1, 0) ((e) in FIG. 30). The data c(0, 0) retained in the FF4 of the PE+(1) is transferred to the FF4 of the PE+(0) ((f) in FIG. 30). As a result, the FF4 of the PE+(0) and PE+(1) returns to the initial state of retaining the data c(0, 0) and a(1, 0), respectively. However, the data c(0, 0) and a(1, 0) are not the original data, but are the product-sum operation results.

The data c(0, 0) retained in the FF3 of the PE+(1) is stored in the FF3 of the PE+(4) without being input to the FMA of the PE+(4) ((g) in FIG. 30). For example, the matrix multiplication result of the upper subarray bypasses the FMA toward the bus BUS without being operated by the lower subarray. The bypass of the matrix multiplication result may be achieved by a bypass path directly coupling the output of the MUX4 to the input of the MUX5 in each PE+ being provided. Note that the power consumption of the systolic array 100 may be reduced by the clock supplied to the bypassed FMA being stopped.

The data c(1, 1) retained in the FF4 of the PE+(2) is added to the multiplication result of the PE+(2), and the addition result is stored in the FF3 of the PE+(2) as data c(1, 1) ((h) in FIG. 30). The data c(0, 1) retained in the FF3 of the PE+(2) is added to the multiplication result of the PE+(3), and the addition result is stored in the FF3 and FF4 of the PE+(3) as data c(0, 1) ((i) in FIG. 30).

Operations of the PE+(4) to PE+(7) are similar to the operations of the PE+(0) to PE+(3) except that the data c(1, 0) and c(0, 1), which are the product-sum operation results of the PE+(5) and PE+(7), are not only stored in the FF3 and FF4, respectively, but also output to the bus BUS ((j) and (k) in FIG. 30).

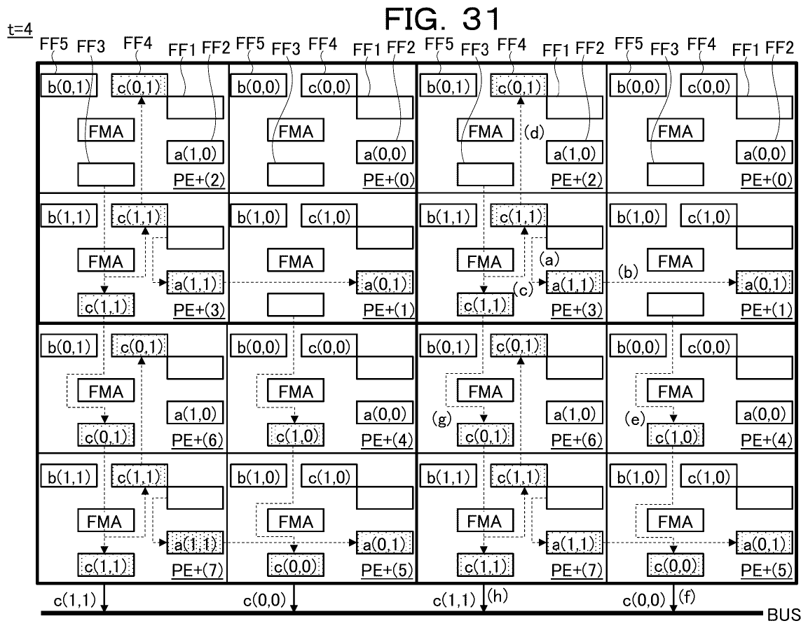

In FIG. 31 (clock cycle t=4), the data a(1, 1) retained in the FF1 of the PE+(3) is transferred to the FF2 of the PE+(3) ((a) in FIG. 31). The data a(0, 1) retained in the FF2 of the PE+(3) is transferred to the FF2 of the PE+(1) ((b) in FIG. 31). As a result, the FF2 of the PE+(1) and PE+(2) returns to the initial state of retaining the data a(0, 1) and a(1, 1), respectively.

The data c(1, 1) retained in the FF3 of the PE+(2) is added to the multiplication result of the PE+(2), and the addition result is stored in the FF3 and FF4 of the PE+(3) as data c(1, 1) ((c) in FIG. 31). The data c(0, 1) retained in the FF4 of the PE+(3) is transferred to the FF4 of the PE+(2) ((d) in FIG. 31). As a result, the FF4 of the PE+(2) and PE+(3) returns to the initial state of retaining the data c(0, 1) and a(1, 1), respectively. However, the data c(0, 1) and a(1, 1) are not the original data, but are the product-sum operation results.

The data c(1, 0) retained in the FF3 of the PE+(1) is stored in the FF3 of the PE+(4) without being input to the FMA of the PE+(4) ((e) in FIG. 31). The data c(0, 0) retained in the FF2 of the PE+(4) is stored in the FF3 of the PE+(5) and output to the bus BUS without being input to the FMA of the PE+(5) ((f) in FIG. 31).

The data c(0, 1) retained in the FF3 of the PE+(3) is stored in the FF3 of the PE+(6) without being input to the FMA of the PE+(6) ((g) in FIG. 31). The transfer of (e), (f), and (g) in FIG. 31 is a bypass operation of transferring the matrix multiplication result of the upper subarray to the bus BUS without being computed by the FMA of the lower subarray.

Operations of the PE+(4) to PE+(7) are similar to the operations of the PE+(0) to PE+(3) except that the data c(1, 1), which is the product-sum operation result of the PE+(7), is output to the bus BUS ((h) in FIG. 31) and the matrix multiplication result from the upper subarray bypasses the FMA.

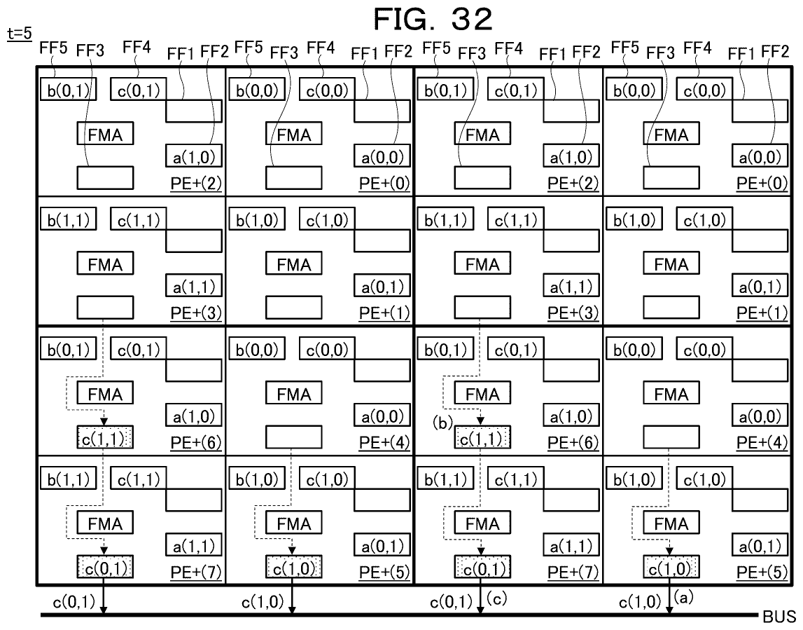

In FIGS. 32 (clock cycle t=5) and 33 (clock cycle t=6), no matrix multiplication is executed by the FMA, and the multiplication result of the upper subarray is transferred to the bus BUS. Note that, since the upper subarray returns to the initial state, it stops the operation.

In FIG. 32, the data c(1, 0) retained in the FF3 of the PE+(4) is stored in the FF3 of the PE+(5) and output to the bus BUS without being input to the FMA of the PE+(5) ((a) in FIG. 32). The data c(1, 1) retained in the FF3 of the PE+(3) is stored in the FF3 of the PE+(6) without being input to the FMA of the PE+(6) ((b) in FIG. 32). The data c(0, 1) retained in the FF3 of the PE+(6) is stored in the FF3 of the PE+(6) and output to the bus BUS without being input to the FMA of the PE+(7) ((c) in FIG. 32).

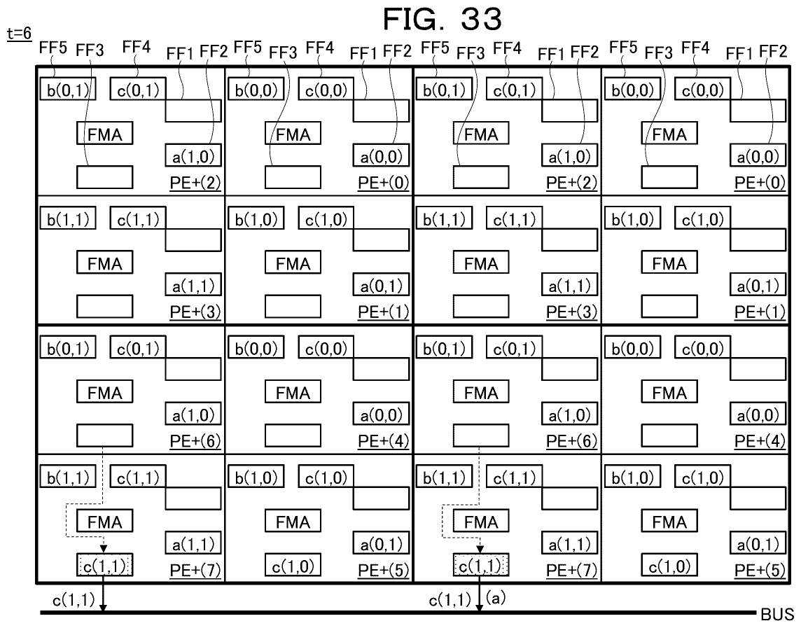

In FIG. 33, the data c(1, 1) retained in the FF3 of the PE+(6) is stored in the FF3 of the PE+(6) and output to the bus BUS without being input to the FMA of the PE+(7) ((a) in FIG. 33).

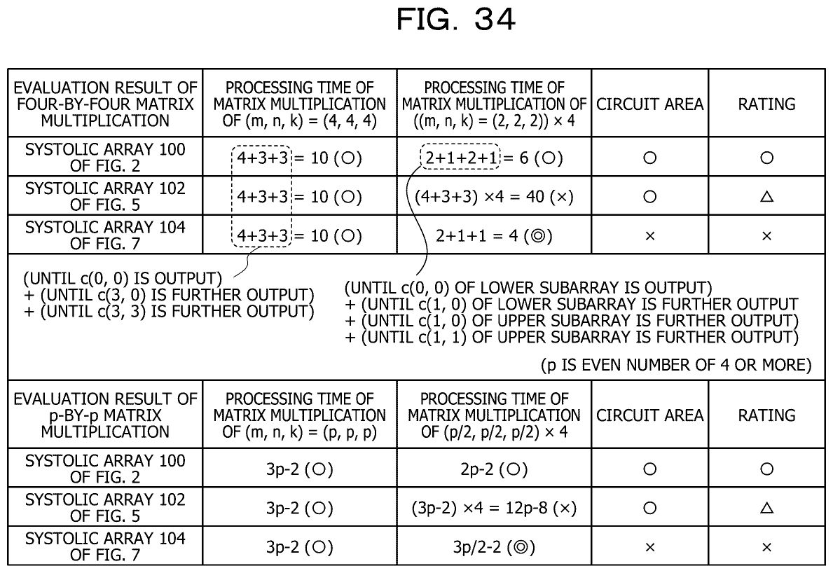

FIG. 34 illustrates features of the systolic array matrix multipliers in FIGS. 2, 5, and 7. A circle in the table indicates a status good, a double circle indicates a status best, a triangle indicates a status not good, and a cross indicates a status problematic. FIG. 34 illustrates an evaluation result of four-by-four matrix multiplication and an evaluation result of p-by-p matrix multiplication (p is an integer of 4 or more). Each evaluation result was determined based on the processing time of the four-by-four or p-by-p matrix multiplication, the processing time of two-by-two or (p/2)-by-(p/2) matrix multiplication, and the circuit area of the systolic arrays 100, 102, and 104.

The evaluation of the four-by-four matrix multiplication was obtained by summing the processing times of the following (a) to (c).

(a) Number of clock cycles (=4) until the first matrix multiplication result c(0, 0) is output from each of the systolic arrays 100, 102, and 104

(b) Moreover, the number of clock cycles (=3) until the last matrix multiplication result c(3, 0) is output from each of the systolic arrays 100, 102, and 104 from the right column

(c) Moreover, the number of clock cycles (=3) until the last matrix multiplication result c(3, 3) is output from each of the systolic arrays 100, 102, and 104

The evaluation of the systolic array 100 that executes four two-by-two matrix multiplications was obtained by summing the processing times of the following (d) to (g).

(d) Number of clock cycles (=2) until the first matrix multiplication result c(0, 0) of the lower subarray is output from the systolic array 100

(e) Moreover, the number of clock cycles (=1) until the last matrix multiplication result c(1, 0) of the lower subarray is output from the systolic array

(f) Moreover, the number of clock cycles (=2) until the last matrix multiplication result c(1, 0) in the right column of the upper subarray is output from the systolic array 100

(g) Moreover, the number of clock cycles (=1) until the last matrix multiplication result c(1, 1) of the upper subarray is output from the systolic array 100

In the evaluation of the systolic array 102 that executes four two-by-two matrix multiplications, the processing time was calculated on the assumption that the four-by-four matrix multiplication is repeated four times.

The evaluation of the systolic array 104 that executes four two-by-two matrix multiplications was obtained by summing the processing times of the following (h) to (j). Here, the subarray includes four pieces of PE+ of two rows and two columns.

(h) Number of clock cycles (=2) until the first matrix multiplication result c(0, 0) of the four subarrays is output from the systolic array 104

(i) Moreover, the number of clock cycles (=1) until the last matrix multiplication result c(1, 0) in the right column of the four subarrays is output from the systolic array 104

(j) Moreover, the number of clock cycles (=1) until the last matrix multiplication result c(1, 1) in the left column of the four subarrays is output from the systolic array 104

There was no significant difference in the processing time of the four-by-four matrix multiplication among the systolic arrays 100, 102, and 104. The processing time of the two-by-two matrix multiplication was the best in the systolic array 104, good in the systolic array 100, and problematic in the systolic array 102.

The circuit area was good in the systolic arrays 100 and 102, and problematic in the systolic array 104. As a result, the systolic arrays 100, 102, and 104 were rated higher in that order. Also in the evaluation of the p-by-p matrix multiplication, in a similar manner to the evaluation of the four-by-four matrix multiplication, the systolic arrays 100, 102, and 104 where rated higher in that order.

As described above, in this embodiment, the data of the matrix A transferred from the left side to the right side may be turned leftward at any PE+ and retained, and the data of the matrix A transferred from the right side to the left side may be turned rightward at any PE+ and retained. Furthermore, the systolic array 100 may turn and retain the data of the matrix C transferred from the upper side to the lower side upward at any PE+, and may turn and retain the data of the matrix C transferred from the lower side to the upper side downward at any PE+.

As a result, the data a and c may be supplied to each PE+ without using the bus BUS during the execution of the matrix multiplication by the systolic array 100. Since no data is transferred from the memory 220 to the systolic array 100 during the execution of the matrix multiplication by the systolic array 100, the band of the bus BUS between the systolic array 100 and the memory 220 may be made smaller. As a result, a decrease in operation performance caused by the band limitation of the bus BUS may be suppressed.

When the systolic array 100 completes the matrix multiplication, the data of the matrix A and the data of the matrix C are returned to be at the initial positions. As a result, the next matrix multiplication may be started without inputting the data a, b, and c from the bus BUS to each PE+, whereby an increase in the band of the bus BUS may be suppressed.

As illustrated in FIGS. 20 to 26, in the case of changing the data of the matrices A and C to be used in the matrix multiplication to be executed next from the data of the matrices A and C used in the matrix multiplication currently executed, the data may be transferred to each PE+ during the execution of the matrix multiplication. As a result, after the execution of the current matrix multiplication is complete, the next matrix multiplication may be started without transferring the data from the memory 220 via the bus BUS. Since the operation of the systolic array 100 may be changed depending on whether or not the data of the matrices A and C used in the previous matrix multiplication is to be used in the next matrix multiplication, the usability of the systolic array 100 may improve.

As illustrated in FIGS. 27 to 33, the systolic array 100 may be divided into a plurality of subarrays to execute matrix multiplication in parallel in the plurality of subarrays. At this time, the matrix multiplication may be executed in parallel without the memory MEM provided for each subarray as illustrated in FIG. 7. Therefore, matrix multiplication of a plurality of sizes of systolic arrays may be executed in one systolic array 100 without increasing the circuit scale of the systolic array 100 and the information processing apparatus 200 in which the systolic array 100 is installed.

Moreover, as illustrated in FIGS. 30 to 33, the matrix multiplication result of the upper subarray may be output to the bus BUS while bypassing the FMA of the lower subarray, whereby a correct matrix multiplication result may be output. The operation of bypassing the FMA of the lower subarray may be achieved by the MUX5 being provided in the PE+ and the path directly coupling between the MUX4 and MUX5 being provided in FIG. 2. For example, the power consumption of the systolic array 100 may be reduced by the clock supplied to the bypassed FMA being stopped.

Note that, while FIG. 1 exemplifies the systolic array 100 including four pieces of PE+ in the vertical direction and four pieces of PE+ in the horizontal direction to simplify descriptions, the systolic array 100 may be larger in scale, such as including 128 pieces of PE+ in the vertical direction and 128 pieces of PE+ in the horizontal direction, including 256 pieces of PE+ in the vertical direction and 256 pieces of PE+ in the horizontal direction, or the like. In this case, multiple matrix multiplications of any of two-by-two, four-by-four, eight-by-eight, . . . , 32-by-32, 64-by-64, and the like may be executed in parallel without adding memory.

From the detailed descriptions above, characteristics and advantages of the embodiment will become apparent. This intends that the claims cover the characteristics and advantages of the embodiment described above without departing from the spirit and the scope of the claims. Furthermore, any person having ordinary knowledge in the technical field is to be able to easily conceive various improvements and modifications. Therefore, there is no intention to limit the scope of the inventive embodiment to those described above, and the scope of the inventive embodiment may rely on appropriate improvements and equivalents included in the scope disclosed in the embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A systolic array matrix multiplier configured to execute matrix multiplication, the systolic array matrix multiplier comprising a plurality of processing elements arranged in a matrix, wherein
each of the plurality of processing elements includes:
a first holder that sequentially retains each element of a first matrix received from a first input terminal provided on one end side in a first direction;
a first path that outputs an output of the first holder to a first output terminal provided on another end side in the first direction;
a second holder that sequentially retains each element of the first matrix received from a second input terminal provided on the another end side in the first direction;
a second path that outputs an output of the second holder to a second output terminal provided on the one end side in the first direction;
a product-sum operator coupled to the first path;
a first selector that couples the first path or the second input terminal to the second path; and
a second selector that couples the second path or the output of the first holder to the first path.

2. The systolic array matrix multiplier according to claim 1, wherein
a processing element arranged at the one end in the first direction among the plurality of processing elements couples the second path to the first path using the second selector,
a processing element arranged at the another end in the first direction among the plurality of processing elements couples the first path to the second path using the first selector, and
a processing element arranged at a position other than the one end in the first direction and the another end in the first direction among the plurality of processing elements couples the output of the first holder to the first path using the second selector, and couples the second input terminal to an input of the second holder using the first selector.

3. The systolic array matrix multiplier according to claim 1, wherein
when the plurality of processing elements is partitioned into a plurality of subarrays that includes i×j pieces of the processing elements of i rows and j columns (i and j are integers of 2 or more) and the matrix multiplication is executed in each of the plurality of subarrays,
in each of the plurality of subarrays,
a processing element arranged at the one end in the first direction among the plurality of processing elements couples the second path to the first path using the second selector,
a processing element arranged at the another end in the first direction among the plurality of processing elements couples the first path to the second path using the first selector, and
a processing element arranged at a position other than the one end in the first direction and the another end in the first direction among the plurality of processing elements couples the output of the first holder to the first path using the second selector, and couples the second input terminal to an input of the second holder using the first selector.

4. The systolic array matrix multiplier according to claim 1, wherein
each of the plurality of processing elements includes:
a third path that outputs, to the product-sum operator, each element of a second matrix received from a third input terminal provided on one end side in a second direction that intersects the first direction;
a third holder that sequentially retains an operation result output from the product-sum operator and outputs the operation result to a third output terminal provided on another end side in the second direction;
a fourth holder that sequentially retains each element of the second matrix received from a fourth input terminal provided on the another end side in the second direction;
a fourth path that outputs an output of the fourth holder to a fourth output terminal provided on the one end side in the second direction;
a third selector that couples the third path or the fourth input terminal to the fourth path; and
a fourth selector that couples the fourth path or the third input terminal to the third path.

5. The systolic array matrix multiplier according to claim 4, wherein
a processing element arranged at the one end in the second direction among the plurality of processing elements couples the fourth path to the third path using the fourth selector,
a processing element arranged at the another end in the second direction among the plurality of processing elements couples the third path to the fourth path using the third selector, and
a processing element arranged at a position other than the one end in the second direction and the another end in the second direction among the plurality of processing elements couples the third input terminal to the third path using the fourth selector, and couples the fourth input terminal to the fourth path using the third selector.

6. The systolic array matrix multiplier according to claim 4, wherein
when the plurality of processing elements is partitioned into a plurality of subarrays that includes i×j pieces of the processing elements of i rows and j columns (i and j are integers of 2 or more) and the matrix multiplication is executed in each of the plurality of subarrays,
in each of the plurality of subarrays,
a processing element arranged at the one end in the second direction among the plurality of processing elements couples the fourth path to the third path using the fourth selector,
a processing element arranged at the another end in the second direction among the plurality of processing elements couples the third path to the fourth path using the third selector, and
a processing element arranged at a position other than the one end in the second direction and the another end in the second direction among the plurality of processing elements couples the third input terminal to the third path using the fourth selector, and couples the fourth input terminal to the fourth path using the third selector.

7. The systolic array matrix multiplier according to claim 6, wherein
each of the plurality of processing elements includes a fifth selector that that couples an output of the product-sum operator or the third path to the third holder,
the third holder retains the operation result output from the product-sum operator or the operation result output from the product-sum operator of the processing element arranged on the one end side in the second direction, and
the processing element included in a subarray in which another subarray is arranged at the one end in the second direction among the plurality of subarrays is configured to:
couple the third input terminal to the third holder using the fourth selector or the fifth selector when a matrix multiplication result is transferred from the another subarray.

8. A method of operating a systolic array matrix multiplier which is configured to execute matrix multiplication and includes a plurality of processing elements arranged in a matrix, each of the plurality of processing elements includes:
a first holder that sequentially retains each element of a first matrix received from a first input terminal provided on one end side in a first direction;
a first path that outputs an output of the first holder to a first output terminal provided on another end side in the first direction;
a second holder that sequentially retains each element of the first matrix received from a second input terminal provided on the another end side in the first direction;
a second path that outputs an output of the second holder to a second output terminal provided on the one end side in the first direction;
a product-sum operator coupled to the first path;
a first selector that couples the first path or the second input terminal to the second path; and
a second selector that couples the second path or the output of the first holder to the first path, the method comprising:
coupling, by a processing element arranged at the one end in the first direction among the plurality of processing elements which are included in the systolic array matrix multiplier, the second path to the first path using the second selector;
coupling, by a processing element arranged at the another end in the first direction among the plurality of processing elements, the first path to the second path using the first selector; and
coupling, by a processing element arranged at a position other than the one end in the first direction and the another end in the first direction among the plurality of processing elements, the output of the first holder to the first path using the second selector and coupling the second input terminal to an input of the second holder using the first selector.

9. The method according to claim 8, wherein
when the plurality of processing elements is partitioned into a plurality of subarrays that includes i×j pieces of the processing elements of i rows and j columns (i and j are integers of 2 or more) and the matrix multiplication is executed in each of the plurality of subarrays,
in each of the plurality of subarrays,
a processing element arranged at the one end in the first direction among the plurality of processing elements couples the second path to the first path using the second selector,
a processing element arranged at the another end in the first direction among the plurality of processing elements couples the first path to the second path using the first selector, and
a processing element arranged at a position other than the one end in the first direction and the another end in the first direction among the plurality of processing elements couples the output of the first holder to the first path using the second selector, and couples the second input terminal to an input of the second holder using the first selector.

10. The method according to claim 8, wherein
each of the plurality of processing elements includes:
a third path that outputs, to the product-sum operator, each element of a second matrix received from a third input terminal provided on one end side in a second direction that intersects the first direction;
a third holder that sequentially retains an operation result output from the product-sum operator and outputs the operation result to a third output terminal provided on another end side in the second direction;
a fourth holder that sequentially retains each element of the second matrix received from a fourth input terminal provided on the another end side in the second direction;
a fourth path that outputs an output of the fourth holder to a fourth output terminal provided on the one end side in the second direction;
a third selector that couples the third path or the fourth input terminal to the fourth path; and
a fourth selector that couples the fourth path or the third input terminal to the third path,
wherein the method further includes:
coupling, by a processing element arranged at the one end in the second direction among the plurality of processing elements, the fourth path to the third path using the fourth selector;
coupling, by a processing element arranged at the another end in the second direction among the plurality of processing elements, the third path to the fourth path using the third selector; and
coupling, by a processing element arranged at a position other than the one end in the second direction and the another end in the second direction among the plurality of processing elements, the third input terminal to the third path using the fourth selector, and coupling the fourth input terminal to the fourth path using the third selector.

11. The method according to claim 10, wherein
when the plurality of processing elements is partitioned into a plurality of subarrays that includes i×j pieces of the processing elements of i rows and j columns (i and j are integers of 2 or more) and the matrix multiplication is executed in each of the plurality of subarrays,
in each of the plurality of subarrays,
a processing element arranged at the one end in the second direction among the plurality of processing elements couples the fourth path to the third path using the fourth selector,
a processing element arranged at the another end in the second direction among the plurality of processing elements couples the third path to the fourth path using the third selector, and
a processing element arranged at a position other than the one end in the second direction and the another end in the second direction among the plurality of processing elements couples the third input terminal to the third path using the fourth selector, and couples the fourth input terminal to the fourth path using the third selector.

12. The method according to claim 11, wherein
each of the plurality of processing elements includes a fifth selector that that couples an output of the product-sum operator or the third path to the third holder,
the third holder retains the operation result output from the product-sum operator or the operation result output from the product-sum operator of the processing element arranged on the one end side in the second direction, and
the processing element included in a subarray in which another subarray is arranged at the one end in the second direction among the plurality of subarrays is configured to:
couple the third input terminal to the third holder using the fourth selector or the fifth selector when a matrix multiplication result is transferred from the another subarray.
